(19) United States
(12) Patent Application Publication
(10) Pub. No.: US 2016/0245961 A1
(43) Pub. Date: Aug. 25, 2016

(54) LENS ARRAY SUBSTRATE, ELECTROOPTICAL DEVICE, ELECTRONIC APPARATUS, AND METHOD OF MANUFACTURING LENS ARRAY SUBSTRATE

(71) Applicant: Seiko Epson Corporation, Tokyo (JP)

(72) Inventor: Koichiro Akasaka, Ina-shi (JP)

(21) Appl. No.: 15/041,937

(22) Filed: Feb. 11, 2016

(30) Foreign Application Priority Data
Feb. 19, 2015 (JP) 2015-030391

(51) Int. Cl. G02B 3/00; G02F 1/1335

(52) U.S. Cl. CPC G02B 3/0068; G02B 3/0056; G02B 3/0012; G02F 1/133526; G02F 1/133512

(57) ABSTRACT

A microlens array substrate includes: a substrate including concave portions in a display region on a surface; a first lens layer being formed so as to cover the surface and filling the concave portions; an intermediate layer being formed so as to cover the first lens layer; a light shielding portion being formed in a parting region on the intermediate layer; a second lens layer being formed so as to cover the intermediate layer and the light shielding portion and including convex portions arranged so as to overlap the concave portions in a plane and the convex portions arranged so as to overlap the light shielding portion in a plane; and an optical path length adjustment layer being formed so as to cover the second lens layer and including a flat surface, and the convex portions being arranged in a line so as to surround the convex portions.

### BACKGROUND

1. Technical Field

The present invention relates to a lens array substrate, an electrooptical device, an electronic apparatus, and a method of manufacturing a lens array substrate.

2. Related Art

An electrooptical device with an electrooptical substance, such as liquid crystal, between an element substrate and a facing substrate is known. As such an electrooptical device, a liquid crystal device used as a liquid crystal light valve for a projector can be exemplified. In the liquid crystal device, a light shielding portion is provided in a region in which switching elements, wirings, and the like are arranged, and a part of incident light is blocked by the light shielding portion and is not utilized. Thus, a configuration for enhancing the efficiency of utilizing light in the liquid crystal device by providing lenses (microlenses) on a side of one substrate, causing the lenses to collect the light, which is blocked by the light shielding portion arranged at a boundary between pixels, as a part of the light that is incident on the liquid crystal device, and causing the collected light to be incident on the inside of openings of pixels is known (see JP-A-11-202314 and JP-A-2009-271468, for example).

According to the liquid crystal device disclosed in JP-A-11-202314, a light blocking film is formed of a metal material such as chromium, nickel, or aluminum in a parting region (peripheral parting region) in a periphery of a display region. In addition, convex microlenses that are curved toward the outside from the substrate are arranged in the display region, and convex dummy microlenses that are curved toward the outside from the substrate are arranged in the parting region so as to overlap the light blocking film in plan view. The microlenses that are curved toward the outside from the substrate are formed by transferring lens shapes, which are formed by exposing a photosensitive material to light, patterning the photosensitive material, and performing heat treatment thereon, to a substrate by anisotropic etching. Since the amount of removal is larger in the outermost periphery than the inside thereof in the anisotropic etching and differences in the shapes of the microlenses occur, variations in the properties of the microlenses occur. Thus, dummy microlenses that do not contribute to display are arranged in the periphery of the microlenses so as to prevent the occurrence of differences in the shapes of the microlenses in the display region. The plurality of dummy microlenses are formed on one side in one horizontal scanning direction, and the number thereof is not particularly limited.

According to the liquid display device disclosed in JP-A-2009-271468, concave portions are formed in a display region on a substrate, and a groove is formed in a parting region. In addition, convex microlenses that are curved toward the side of the substrate are formed by filling the concave portions in the substrate with a lens layer (filling layer) made of resin or an inorganic material, and an optical path length adjustment layer (cover layer) for adjusting a focal distance of the microlenses is formed of resin or an inorganic material so as to cover the lens layer. Since the lens layer is formed so as to be lifted in the parting region in a case in which the groove is not formed in the parting region, a large level difference is generated on the surface of the lens layer between the display region and the parting region, which brings about an increase in the number of processes such as polishing for flattening the surface of the lens layer. For this reason, the level difference in the surface of the lens layer between the display region and the parting region is suppressed by forming the groove in the parting region, and it is attempted to reduce the number of processes in the flattening processing such as polishing.

Incidentally, in the liquid crystal device described in JP-A-11-202314, light reflected by the light blocking film that is formed of the metal material is added in the parting region when the photosensitive material is exposed to light. Therefore, the intensity of light with which the photosensitive material is irradiated further increases as compared with that in the display region. For this reason, the diameter of each dummy microlens that is formed in the parting region becomes smaller than the diameter of each microlens in the display region. In doing so, the shapes of the microlenses in the display region and the shapes of the dummy microlenses with a smaller diameter in the parting region are reflected on the surface of the optical path length adjustment layer in the case in which the optical path length adjustment layer is formed so as to cover the convex microlenses. Therefore, since the density of the material of the optical path length adjustment layer per unit volume during the polishing differs between the display region and the parting region due to the difference in the diameters of the microlenses and the dummy microlenses in the process of flattening the surface of the optical path length adjustment layer, the number of processes in the flattening processing increases. However, JP-A-11-202314 does not include any consideration about the flattening processing in the case in which the optical path length adjustment layer is formed so as to cover the microlens since a structure of attaching a cover glass to the side, on which the microlenses are formed, of the substrate with an adhesive is employed.

It is possible to suppress a large level difference between the region in which the dummy microlenses are arranged and the peripheral region thereof, which is generated on the surface of the optical path length adjustment layer by further forming the groove as disclosed in JP-A-2009-271468 in the periphery of the dummy microlenses in the parting region. However, the density of the material of the optical path length adjustment layer per unit volume in the process of flattening the surface of the optical path length adjustment layer differs in three different levels in the display region in which the microlenses are arranged, the peripheral region in which the dummy microlenses are arranged, and the further peripheral region in which the groove is formed in this case. Therefore, there is concern that the number of processes such as polishing for flattening the surface of the optical path length adjustment layer increases depending on the setting of the depth, the width, and the like of the groove, and that productivity deteriorates.

### SUMMARY

The invention can be realized in the following aspects or application examples.

### APPLICATION EXAMPLE 1

According to this application example, there is provided a lens array substrate including: a substrate that includes a plurality of concave portions in a first region on a first surface; a first lens layer that is formed of a material with an optical refraction index difference from that of the substrate so as to cover the first surface and fill the plurality of concave portions; a first light transmitting layer that is formed so as to cover the first lens layer; a light shielding portion that is formed in a second region surrounding the first region on the first light transmitting layer; a second lens layer that is formed so as to cover the first light transmitting layer and the light shielding portion and includes a plurality of first convex portions arranged in the first region so as to overlap the respective concave portions in a plane and a plurality of second convex portions arranged in the second region so as to overlap the light shielding portion in a plane; and a second light transmitting layer that is formed of a material with an optical refraction index difference from that of the second lens layer so as to cover the second lens layer and includes a substantially flat surface, in which the plurality of second convex portions are arranged in a line so as to surround the plurality of first convex portions.

According to the configuration of this application example, the lens array substrate includes, in the first region, a two-stage lens array of lenses that are formed by filling the concave portions of the substrate with the first lens layer and are curved toward the side of the substrate and lenses that are formed by covering the first convex portions of the second lens layer with the second light transmitting layer and are curved toward the opposite side to the substrate. In addition, the lens array substrate includes, in the second region, dummy lenses that are formed by covering the second convex portions arranged in the periphery of the first convex portions of the second lens layer with the second light transmitting layer and overlap the light shielding portion in a plane. Therefore, since the second convex portions are formed in the periphery of the first convex portions when the first convex portions are formed by transferring lens shapes formed by exposing a photosensitive material to light, patterning the photosensitive material, and performing heat treatment thereon to the second lens layer by anisotropic etching, it is possible to further reduce the differences in shape of the first convex portions arranged in the first region and to further uniformize the properties of the lenses as compared with a case in which the second convex portions are not formed.

According to such a lens array substrate, the diameter of the second convex portions that overlap the light shielding portion in a plane is smaller than the diameter of the first convex portions due to light reflected by the light shielding portion when the lens shape is formed by exposing the photosensitive material layer to light. Therefore, a difference in the density of the material of the second light transmitting layer per unit volume occurs at a portion at which the first convex portions and the second convex portions are adjacent to each other when the surface of the second light transmitting layer that reflects the shapes of the first convex portions and the shapes of the second convex portions is flattened. Here, since the second convex portions that are arranged in the periphery of the first convex portions are in a line in this application example, it is possible to reduce the difference in the density of the material of the second light transmitting layer per unit volume between the first region in which the first convex portions are arranged and the second region in which the second convex portions are arranged as compared with a case in which the second convex portions are arranged in a plurality of lines. In doing so, it is possible to enhance flatness of the surface of the second light transmitting layer that functions as a superficial layer of the lens array substrate. In addition, it is possible to reduce the number of processes in the flattening processing of the second light transmitting layer in manufacturing the lens array substrate and to thereby enhance productivity of the lens array substrate.

### APPLICATION EXAMPLE 2

In the lens array substrate according to the application example, it is preferable that the second lens layer includes a third convex portion that is provided in the second region so as to overlap the light shielding portion in a plane and is arranged so as to surround the plurality of second convex portions.

According to the configuration of this application example, the third convex portion is arranged in the periphery of second convex portions on the second lens layer. Therefore, it is possible to reduce the difference in the density of the material of the second light transmitting layer per unit volume between the region in which the second convex portions are arranged and a peripheral region in which the third convex portion is arranged. In doing so, it is possible to further enhance the flatness of the surface of the lens array substrate. In addition, it is possible to further reduce the number of processes in the flattening processing of the second light transmitting layer in manufacturing the lens array substrate.

### APPLICATION EXAMPLE 3

In the lens array substrate according to the application example, it is preferable that the third convex portion is provided in a frame shape.

According to the configuration of this application example, the third convex portion is provided in a frame shape in the periphery of the second convex portions that are arranged in a line in the periphery of the first region. Therefore, the continuing third convex portion is arranged at positions of the respective sides of the frame shape so as to face the second convex portions that are aligned in a line. Therefore, it is possible to reduce the difference in the density of the material of the second light transmitting layer per unit volume between the region in which the second convex portions are arranged and the third convex portion is arranged at the positions of the respective sides of the frame shape.

### APPLICATION EXAMPLE 4

In the lens array substrate according to the application example, it is preferable that the concave portions, the first convex portions, and the second convex portions are arranged at substantially the same arrangement pitch in a first direction and a second direction that intersects the first direction, and that the width of a portion of the third convex portion in the first direction and the width of a portion of the third convex portion in the second direction are equal to or less than ½ of the arrangement pitch.

According to the configuration of this application example, the second convex portions are arranged in the first direction and the second direction at substantially the same arrangement pitch, and the width of the third convex portion, which is arranged in the frame shape in the periphery thereof, in the first direction and the second direction is equal to or less than ½ of the arrangement pitch of the second convex portions. Therefore, since the second convex portions that are aligned in a line at substantially the same arrangement pitch and the third convex portion that continues with a width of equal to or less than ½ of the arrangement pitch are arranged at the positions of the respective sides of the frame shape of the third convex portion so as to face each other, it is possible to further reduce the difference in the density of the material of the second light transmitting layer per unit volume between the region in which the second convex portions are arranged and the region in which the third convex portion is arranged.

### APPLICATION EXAMPLE 5

In the lens array substrate according to the application example, the diameter of the second convex portions may be smaller than the diameter of the first convex portions.

According to the configuration of this application example, the dummy lens that is formed by covering the second convex portions with the second light transmitting layer is arranged so as to overlap the light shielding portion in a plane. Therefore, light that is incident on the lens array substrate is not transmitted through the dummy lens. For this reason, since the diameter of the second convex portions is smaller than the diameter of the first convex portions, a difference in the properties of the dummy lenses from those of the lenses that are arranged in the first region does not affect light that is transmitted through the lens array substrate.

### APPLICATION EXAMPLE 6

According to this application example, there is provided an electrooptical device including: a first substrate that includes a plurality of switching elements, each of which is provided for each pixel; a second substrate that includes the lens array substrate according to any one of the aforementioned application examples and is arranged so as to face the first substrate; and an electrooptical layer that is arranged between the first substrate and the second substrate, in which the concave portions and the first convex portions are arranged so as to overlap a region of the pixels in a plane.

According to the configuration of this application example, the electrooptical device is provided with the first substrate that includes switching elements, the second substrate that is arranged so as to face the first substrate, and the electrooptical layer that is arranged between the first substrate and the second substrate. Since the second substrate includes the lens array substrate according to the aforementioned application examples, the flatness of the surface of the second substrate is enhanced, and the lens that is formed of the first convex portions of the second lens layer and has uniform properties is arranged so as to overlap the region of pixels in a plane. In doing so, it is possible to provide an electrooptical device capable of providing bright display and excellent display quality.

### APPLICATION EXAMPLE 7

According to this application example, there is provided an electronic apparatus including: the electrooptical device according to the aforementioned application examples.

According to the configuration of this application example, it is possible to provide an electronic apparatus with bright display and excellent display quality.

### APPLICATION EXAMPLE 8

According to this application example, there is provided a method of manufacturing a lens array substrate including: forming a plurality of concave portions in a first region on a first surface of a substrate; forming, on the substrate, a first lens layer of a material with an optical refraction index difference from that of the substrate so as to cover the first surface and fill the plurality of concave portions; forming a first light transmitting layer so as to cover the first lens layer; forming a light shielding portion in a second region surrounding the first region on the first light transmitting layer; forming a second lens layer so as to cover the first light transmitting layer and the light shielding portion; forming a photosensitive material layer so as to cover the second lens layer; performing patterning for forming a plurality of first island-shaped sections in the first region so as to overlap the respective concave portions in a plane, a plurality of second island-shaped sections arranged in a line in the second region so as to overlap the light shielding portion in a plane and surround the plurality of first island-shaped sections, and a frame-shaped section that is arranged in a frame shape so as to surround the plurality of second island-shaped sections by exposing the photosensitive material layer to light and cutting the photosensitive material layer; performing heat treatment for heating the plurality of first island-shaped sections, the plurality of second island-shaped sections, and the frame-shaped section; performing anisotropic etching on the plurality of first island-shaped sections, the plurality of second island-shaped sections, the frame-shaped section, and the second lens layer to form, on the surface of the second lens layer, a plurality of first convex portions that reflects the shapes of the plurality of first island-shaped sections, a plurality of second convex portions that reflects the shapes of the plurality of second island-shaped sections, and a third convex portion that reflects the shape of the frame-shaped section; removing a peripheral edge of the third convex portion from the side of the surface of the second lens layer by a predetermined thickness; forming a second light transmitting layer of a material with an optical refraction index difference from that of the second lens layer so as to cover the second lens layer; and performing flattening processing of polishing and flattening the surface of the second light transmitting layer.

In the manufacturing method according to this application example, the first island-shaped sections and the second island-shaped sections are formed by cutting the photosensitive material layer in the patterning process, the first island-shaped sections and the second island-shaped sections are formed into lens shapes in the heat treatment process, and the first island-shaped sections in the lens shape and the second island-shaped sections in the lens shape are transferred to the second lens layer in the etching process. In the etching process, the amount of removal is larger in the outermost periphery than the inside thereof. However, the second island-shaped sections are arranged in the periphery of the first island-shaped sections. Therefore, it is possible to reduce the differences in shapes of the first convex portions that reflect the shapes of the first island-shaped sections as compared with a case in which the second island-shaped sections are not provided. In doing so, it is possible to uniformize the properties of the lenses that are arranged in the first region and are formed of the first convex portions and the second light transmitting layer in the second lens layer that reflects the shapes of the first island-shaped sections.

Since the diameter of the second island-shaped sections that are arranged so as to overlap the light shielding portion in a plane is smaller than the diameter of the first island-shaped sections due to the light reflected by the light shielding portion in the patterning process, the diameter of the second convex portions that are formed so as to reflect the shapes of the second island-shaped sections in the etching process is smaller than the diameter of the first convex portions that are formed so as to reflect the shapes of the first island-shaped sections. For this reason, a difference in the density of the material of the second light transmitting layer per unit volume occurs at a portion at which the first convex portions and the second convex portions are adjacent to each other when the surface of the second light transmitting layer that reflects the shapes of the first convex portions and the shapes of the second convex portions in the flattening process. Since the third convex portion is arranged in the periphery of the second convex portions, a difference in the density of the material of the second light transmitting layer occurs at a portion at which the second convex portions and the third convex portion are adjacent to each other when the surface of the second light transmitting layer is flattened. Here, since the second convex portions that are arranged in the periphery of the first convex portions are arranged in a line in this application example, it is possible to further reduce the difference in the density of the material of the second light transmitting layer per unit volume between the first region in which the first convex portions are arranged and the region in which the second convex portions are arranged as compared with a case in which the second convex portions are arranged in a plurality of lines. In addition, since the peripheral edge of the third convex portion is removed from the side of the surface of the second lens layer by the predetermined thickness, it is possible to reduce the difference in the density of the second light transmitting layer per unit volume between the region in which the second convex portions are arranged and the region in which the third convex portion is arranged. In doing so, it is possible to reduce the number of processes due to a decrease in amount of polishing in the flattening processing and to thereby enhance productivity of the lens array substrate. In addition, it is possible to enhance the flatness of the surface of the lens array substrate (second light transmitting layer).

### BRIEF DESCRIPTION OF THE DRAWINGS

The invention will be described with reference to the accompanying drawings, wherein like numbers reference like elements.

FIG. 1 is a plan view schematically showing a configuration of a liquid crystal device according to an embodiment.

FIG. 2 is an equivalent circuit diagram showing an electrical configuration of the liquid crystal device according to the embodiment.

FIG. 3 is a sectional view schematically showing the configuration of the liquid crystal device according to the embodiment.

FIGS. 4A and 4B are diagrams schematically showing a configuration of a microlens array substrate according to the embodiment.

FIGS. 5A to 5E are diagrams schematically showing a method of manufacturing the microlens array substrate according to the embodiment.

FIGS. 6A to 6C are diagrams schematically showing the method of manufacturing the microlens array substrate according to the embodiment.

FIGS. 7A to 7C are diagrams schematically showing the method of manufacturing the microlens array substrate according to the embodiment.

FIGS. 8A to 8C are diagrams schematically showing the method of manufacturing the microlens array substrate according to the embodiment.

FIGS. 9A and 9B are diagrams schematically showing the method of manufacturing the microlens array substrate according to the embodiment.

FIG. 10 is a diagram schematically showing a configuration of a projector as an electronic apparatus according to the embodiment.

### DESCRIPTION OF EXEMPLARY EMBODIMENTS

Hereinafter, a description will be given of an embodiment that realizes the invention with reference to drawings. The drawings used are appropriately shown in an enlarged, contracted, or exaggerated manner so as to show portions to be described in a recognizable state. In addition, components other than those necessary for illustration may be omitted in the drawings in some cases.

In the following embodiment, the description “on the substrate” represents an arrangement in which something is in contact with the top of the substrate, an arrangement in which something is arranged above the substrate with another component therebetween, and such an arrangement in which a portion of something is in contact with the top of the substrate and another portion thereof is arranged with another component therebetween, for example.

### Electrooptical Device

In this embodiment, an active matrix-type liquid crystal device provided with thin film transistors (TFTs) as switching elements of pixels will be exemplified and described as an electrooptical device. The liquid crystal device can be suitably used as a light modulation element (liquid crystal light valve) in a projection-type display apparatus (projector) which will be described later, for example.

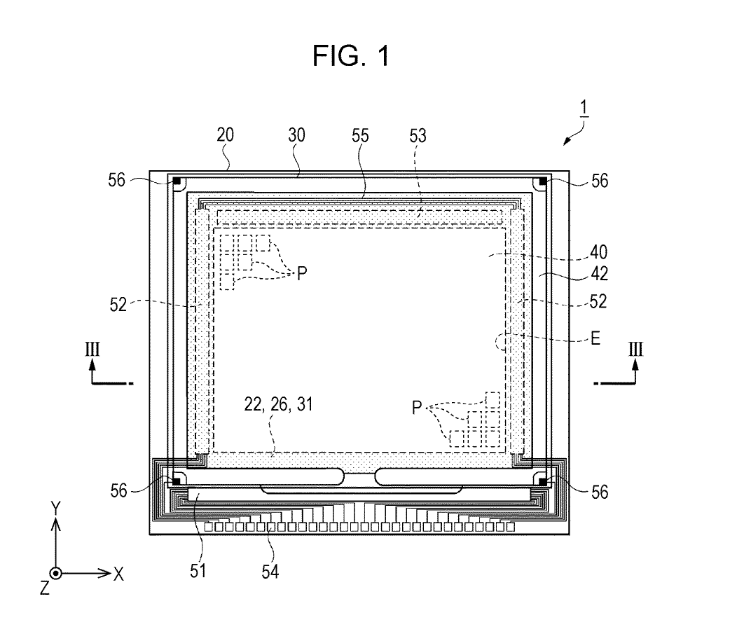

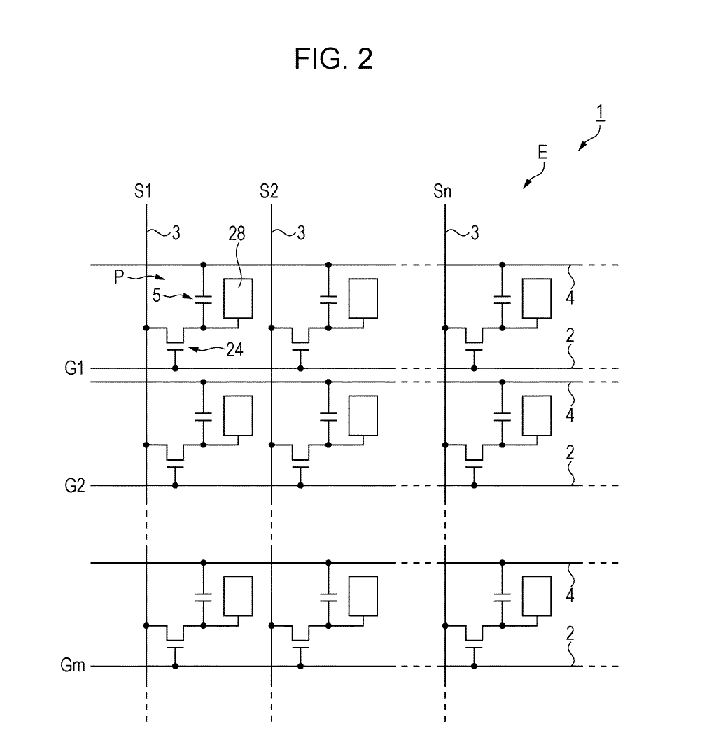

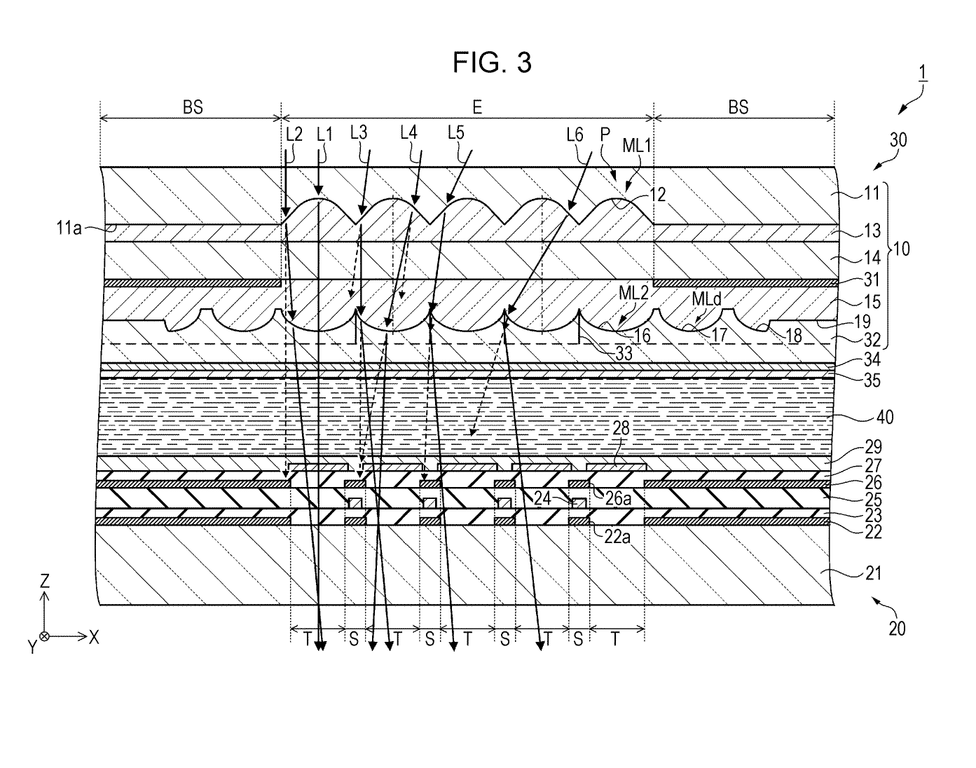

First, a description will be given of a liquid crystal device as an electrooptical device according to the embodiment with reference to FIGS. 1, 2, and 3. FIG. 1 is a plan view schematically showing a configuration of a liquid crystal device according to the embodiment. FIG. 2 is an equivalent circuit diagram showing an electrical configuration of the liquid crystal device according to the embodiment. FIG. 3 is a sectional view schematically showing the configuration of the liquid crystal device according to the embodiment. Specifically, FIG. 3 is a schematic sectional view taken along line III-III in FIG. 1.

As shown in FIGS. 1 and 3, a liquid crystal device 1 according to the embodiment includes an element substrate 20 as the first substrate, a facing substrate 30 as the second substrate that is arranged so as to face the element substrate 20, a sealing material 42, and a liquid crystal layer 40 as an electrooptical layer. As shown in FIG. 1, the element substrate 20 is larger than the facing substrate 30, and the element substrate 20 and the facing substrate 30 are bonded to each other via the sealing material 42 that is arranged in a frame shape along the edge of the facing substrate 30.

The liquid crystal layer 40 is formed of liquid crystal with positive or negative dielectric anisotropy, which is sealed in a space surrounded by the element substrate 20, the facing substrate 30, and the sealing material 42. The sealing material 42 is made of an adhesive of thermosetting or ultraviolet curable epoxy resin, for example. A spacer (not shown) for constantly maintaining a gap between the element substrate 20 and the facing substrate 30 is mixed into the sealing material 42.

Light shielding portions 22 and 26 that are provided on the element substrate 20 and a light shielding portion 31 that is provided on the facing substrate 30 are arranged inside the sealing material 42 arranged in a frame shape. The light shielding portion 31 has a frame shape, and the light shielding portions 22 and 26 have frame-shaped peripheral edges that overlap the light shielding portion 31 in plan view. The inside of the light shielding portion 31 in the frame shape and the portions of the light shielding portions 22 and 26 in the frame shapes correspond to a display region E as the first region in which a plurality of pixels P are aligned. The pixels P have a polygonal plane shape. The pixels P have a substantially rectangular shape, for example, and are aligned in a matrix arrangement.

The display region E in the liquid crystal device 1 is a region that substantially contributes to display. The light shielding portions 22 and 26 on the element substrate 20 are provided in a grid arrangement, for example, in the display region E so as to section opening regions of the plurality of pixels P in a plane. The periphery of the display region E overlaps the light shielding portion 31 provided in the frame shape or the portions of the light shielding portions 22 and 26 in the frame shapes in plan view, and corresponds to a parting region BS as the second region that does not substantially contribute to display (see FIG. 3).

On a side, which is opposite to the display region E, of the sealing material 42 that is formed along a first side of the element substrate 20, a data line driving circuit 51 and a plurality of external connection terminals 54 are provided along the first side. In addition, an inspection circuit 53 is provided on the side of the display region E of the sealing material 42 along a second side that faces the first side. Furthermore, scanning line driving circuits 52 are provided inside the sealing material 42 along the other two sides that perpendicularly intersect the two sides and face each other.

On the side of the display region E of the sealing material 42 along the second side, along which the inspection circuit 53 is provided, a plurality of wirings 55 that connect the two scanning line driving circuits 52 are provided. These wirings that are connected to the data line driving circuit 51 and the scanning line driving circuits 52 are connected to the plurality of external connection terminals 54. In addition, upper and lower conductive sections 56 for establishing electrical conduction between the element substrate 20 and the facing substrate 30 are provided at the corners of the facing substrate 30. The arrangement of the inspection circuit 53 is not limited thereto, and the inspection circuit 53 may be provided at a position along the inside of the sealing material 42 between the data line driving circuit 51 and the display region E.

In the following description, the direction along the first side along which the data line driving circuit 51 is provided will be referred to as an X direction that serves as the first direction, and the direction along the other two sides that perpendicularly intersect the first side and face each other will be referred to as a Y direction that serves as the second direction. The X direction is a direction along line III-III in FIG. 1. The light shielding portions 22 and 26 are provided in the grid arrangement along the X direction and the Y direction. The opening regions of the pixels P are sectioned in the grid arrangement by the light shielding portions 22 and 26 and are aligned in the matrix arrangement in the X direction and the Y direction.

In addition, a direction that perpendicularly intersects the X direction and the Y direction and is directed upward in FIG. 1 will be referred to as a Z direction. In this specification, a view from a normal line direction (Z direction) of the surface of the liquid crystal device 1 on the side of the facing substrate 30 will be referred to as a “plan view”.

As shown in FIG. 2, scanning lines 2 and data lines 3 are formed in the display region E so as to intersect each other, and the pixels P are provided so as to correspond to the intersection between the scanning lines 2 and the data lines 3. The respective pixels P are provided with pixel electrodes 28 and TFTs 24 as switching elements.

Source electrodes (not shown) of the TFTs 24 are electrically connected to the data lines 3 that extend from the data line driving circuit 51. Image signals (data signals) S1, S2, . . . Sn are sequentially supplied from the data line driving circuit 51 (see FIG. 1) to the data lines 3. Gate electrodes (not shown) of the TFTs 24 are parts of the scanning lines 2 that extend from the scanning line driving circuits 52. Scanning signals G1, G2, . . . , Gm are sequentially supplied from the scanning line driving circuits 52 to the scanning lines 2. Drain electrodes (not shown) of the TFTs 24 are electrically connected to the pixel electrodes 28.

The image signals S1, S2, . . . , Sn are written in the pixel electrodes 28 via the data lines 3 at a predetermined timing by turning the TFTs 24 into an ON state only during a predetermined period of time. The image signals in the predetermined level, which have been written in the liquid crystal layer 40 via the pixel electrodes 28 as described above, are held for a predetermined period of time in liquid crystal capacitors that are formed along with a common electrode 34 (see FIG. 3) that is provided on the facing substrate 30.

In order to prevent leakage of the held image signals S1, S2, . . . , Sn, storage capacitors 5 are formed between capacitance lines 4 that are formed along the scanning lines 2 and the pixel electrodes 28 and are arranged in parallel with the liquid crystal capacitors. If a voltage signal is applied to the liquid crystal of the respective pixels P as described above, the orientation state of the liquid crystal varies depending on the level of the applied voltage. In doing so, light that has been incident on the liquid crystal layer 40 (see FIG. 3) is modulated, and it becomes possible to perform gradation display.

The liquid crystal that forms the liquid crystal layer 40 modulates the light in response to variations in orientation and an order of a group of molecules depending on the level of applied voltage and enables gradation display. In the case of a normally white mode, for example, transmittance of the incident light decreases in accordance with the applied voltage in units of respective pixels P. In a case of a normally black mode, the transmittance of the incident light increases in accordance with the applied voltage in units of the respective pixels P, and light with contrast in accordance with the image signals is output from the liquid crystal device 1 as a whole.

As shown in FIG. 3, the element substrate 20 includes a substrate 21, a light shielding portion 22, an insulating layer 23, the TFTs 24, an insulating layer 25, a light shielding portion 26, an insulating layer 27, the pixel electrodes 28, and an orientation film 29. The substrate 21 is made of a light transmitting material such as glass or quartz.

The light shielding portion 22 is provided on the substrate 21. The light shielding portion 22 is formed into a grid arrangement so as to overlap the light shielding portion 26 in the upper layer in plan view. The light shielding portion 22 and the light shielding portion 26 are formed of metal or a metal compound, for example. The light shielding portion 22 and the light shielding portion 26 are arranged so as to interpose the TFTs 24 therebetween in a thickness direction (Z direction) of the element substrate 20. The light shielding portion 22 overlaps at least a channel region of the TFTs 24 in plan view.

It is possible to suppress light that is incident on the TFTs 24 and to thereby suppress erroneous operations due to an increase in optical leakage current or light at the TFTs 24 by providing the light shielding portion 22 and the light shielding portion 26. A region, which overlaps the light shielding portion 22 and the light shielding portion 26 in plan view, of the region of the pixels P corresponds to a light shielding region S through which no light is transmitted. A region surrounded by the light shielding portion 22 (inside the opening 22a) and a region surrounded by the light shielding portion 26 (inside the opening 26a) overlap each other in plan view and correspond to an opening region T, through which light is transmitted, in the region of the pixels P.

The insulating layer 23 is provided so as to cover the substrate 21 and the light shielding portion 22. The insulating layer 23 is made of an inorganic material such as SiO₂.

The TFTs 24 are provided on the insulating layer 23 and are arranged in a region in which the TFTs 24 overlap the light shielding portion 22 and the light shielding portion 26 in plan view. The TFTs 24 are switching elements that drive the pixel electrodes 28. The TFTs 24 are formed of semiconductor layers, the gate electrodes, the source electrodes, and the drain electrodes that are not shown in the drawing. In each semiconductor layer, a source region, a channel region, and a drain region are formed. A lightly doped drain (LDD) region may be formed at an interface between the channel region and the source region or between the channel region and the drain region.

Each gate electrode is formed via a portion (gate insulating film) of the insulating layer 25 in a region, in which the gate electrode overlaps the channel region of the semiconductor layer in plan view, on the element substrate 20. Though not shown in the drawing, the gate electrode is electrically connected to a scanning line arranged on the side of a lower layer via a contact hole, and ON/OFF states of each TFT 24 are controlled by an application of a scanning signal.

The insulating layer 25 is provided so as to cover the insulating layer 23 and the TFTs 24. The insulating layer 25 is made of an inorganic material such as SiO₂. The insulating layer 25 includes a gate insulating film for insulating between the semiconductor layers and the gate electrodes of the TFTs 24. The insulating layer 25 alleviates surface unevenness that is caused by the TFTs 24. The light shielding portion 26 is provided on the insulating layer 25. In addition, the insulating layer 27 made of an inorganic material is provided so as to cover the insulating layer 25 and the light shielding portion 26.

The pixel electrode 28 is provided on the insulating layer 27 so as to correspond to the pixels P. The pixel electrodes 28 are arranged in a region in which the pixel electrodes 28 overlap the opening 22a of the light shielding portion 22 and the opening 26a of the light shielding portion 26 in plan view. The pixel electrodes 28 are made of transparent conductive films of indium tin oxide (ITO) or indium zinc oxide (IZO). The orientation film 29 is provided so as to cover the pixel electrodes 28. The liquid crystal layer 40 is sealed between the orientation film 29 on the side of the element substrate 20 and an orientation film 35 on the side of the facing substrate 30.

Though not shown in the drawing, electrodes, wirings, and relay electrodes for supplying electrical signals to the TFTs 24 and capacitance electrodes configuring the storage capacitors 5 (see FIG. 2) are provided in the region in which these components overlap the light shielding portion 22 and the light shielding portion 26 in plan view. The light shielding portion 22 and the light shielding portion 26 may be configured to include the electrodes, the wirings, the relay electrodes, the capacitance electrodes, and the like.

The facing substrate 30 includes a microlens array substrate 10 as a lens array substrate which will be described later, the common electrode 34, and the orientation film 35. The microlens array substrate 10 includes two-stage microlenses, each of which is formed of a first microlens ML1 and a second microlens ML2 for each pixel P. The common electrode 34 is provided so as to cover the microlens array substrate 10 (optical path length adjustment layer 32). The common electrode 34 is formed so as to be laid across the plurality of pixels P. The common electrode 34 is made of a transparent conductive film of indium tin oxide (ITO) or indium zinc oxide (IZO), for example. The orientation film 35 is provided so as to cover the common electrode 34.

### Microlens Array Substrate

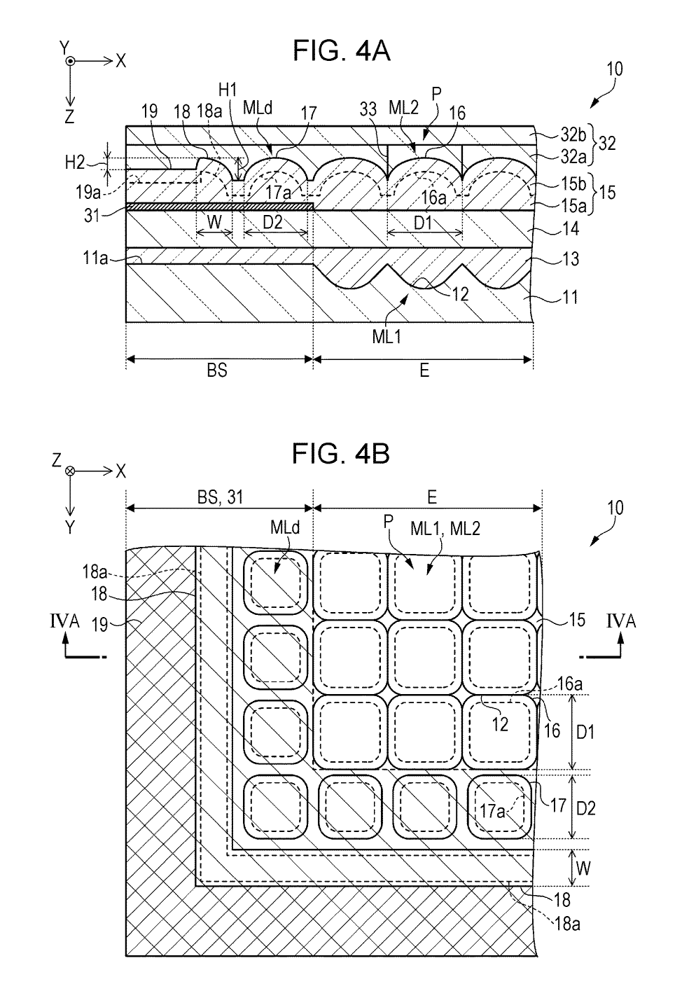

Next, a description will be given of the microlens array substrate according to the embodiment with reference to FIGS. 3 to 4B. FIGS. 4A and 4B are diagrams schematically showing a configuration of the microlens array substrate according to the embodiment. Specifically, FIG. 4A is a sectional view schematically showing the configuration of the microlens array substrate, and FIG. 4B is a plan view schematically showing the configuration of the microlens array substrate. FIG. 4A corresponds to a partially enlarged view of FIG. 3, and the vertical direction (Z direction) is inverted from that in FIG. 3. FIG. 4B is a schematic plan view of the microlens array substrate 10 when viewed from the side of the second lens layer 15 in a state in which the optical path length adjustment layer 32 is removed.

As shown in FIG. 4A, the microlens array substrate 10 includes a substrate 11, a first lens layer 13, an intermediate layer 14 as the first light transmitting layer, a light shielding portion 31, a second lens layer 15, and an optical path length adjustment layer 32 as the second light transmitting layer. In FIG. 4B, the region with hatched lines directed toward the lower right side corresponds to a region in which the light shielding portion 31 is provided, namely the parting region BS.

The substrate 11 shown in FIG. 4A is made of a light transmitting inorganic material such as glass or quartz. The surface, which faces the liquid crystal layer 40 (see FIG. 3), of the substrate 11 will be referred to as a surface 11a as the first surface. The substrate 11 includes a plurality of concave portions 12 that are formed in the display region E on the surface 11a. The respective concave portions 12 are provided for the respective pixels P and are aligned in a matrix arrangement in plan view in the display region E (see FIG. 4B). It is preferable that the concave portions 12 that are adjacent to each other in the X direction and the Y direction are in contact with each other. The concave portions 12 have a sectional shape with a curved surface at the central portion and an inclined surface (so-called tapered surface) at peripheral edge surrounding the curved surface.

The first lens layer 13 is formed to have a thickness that is thicker than the depth of the concave portions 12 so as to cover the surface 11a of the substrate 11 and fill the concave portions 12. The first lens layer 13 has a light transmitting property and is made of a material with an optical refraction index difference from that of the substrate 11. According to the embodiment, the first lens layer 13 is made of an inorganic material with a higher optical refraction index than that of the substrate 11. As such an inorganic material, SiON, Al₂O3, and the like are exemplified.

The first microlenses ML1 with a convex shape that is curved toward the side of the substrate 11 are configured by filling the respective concave portions 12 with the material that forms the first lens layer 13. Therefore, the respective first microlenses ML1 are provided so as to correspond to the pixels P. The plurality of first microlenses ML1 configure a microlens array in a first stage. The first lens layer 13 has a surface that is flat and substantially parallel to the surface 11a of the substrate 11.

Light that is incident on the central portion (curved surface) of each first microlens ML1 from the substrate 11 is collected toward the center (a focal point of the curved surface) of the first microlens ML1 due to a difference in optical refraction indexes of the substrate 11 and the first lens layer 13 (positive refractive power). In addition, light that is incident on the peripheral edges of each first microlens ML1 is refracted to the side of the center of each first microlens ML1 at substantially the same angle in a case of substantially the same incident angle. Therefore, excessive refraction of the incident light is suppressed and variations in angle of the light that is incident on the liquid crystal layer 40 are suppressed as compared with a case in which each first microlens ML1 is entirely formed of a curved surface.

The intermediate layer 14 is formed so as to cover the first lens layer 13. The intermediate layer 14 has a light transmitting property and is made of an inorganic material with substantially the same optical refraction index as that of the substrate 11, for example. As such an inorganic material, SiO₂ and the like are exemplified. The intermediate layer 14 has a function of adjusting a distance from each first microlens ML1 to each second microlens ML2 to a desired value. Therefore, the thickness of the intermediate layer 14 is appropriately set based on optical conditions such as a focal distance of each first microlens ML1 in accordance with a wavelength of light and the like. In addition, the intermediate layer 14 may be formed of the same material as that of the first lens layer 13 or may be formed of the same material as that of the second lens layer 15.

The light shielding portion 31 is formed on the intermediate layer 14. The light shielding portion 31 is formed of metal such as aluminum (Al), metal oxide, or the like. The light shielding portion 31 is formed in a frame shape in the parting region BS that surrounds the display region E as described above. The light that is incident on the parting region BS is blocked or reflected by the light shielding portion 31.

The second lens layer 15 is formed so as to cover the intermediate layer 14 and the light shielding portion 31. The second lens layer 15 includes convex portions 16 as the plurality of first convex portions, convex portions 17 as the plurality of second convex portions, and a convex portion 18 as the third convex portion that are formed on the opposite side to the substrate 11 (the side of the liquid crystal layer 40 shown in FIG. 3). The convex portions 16 and the convex portions 17 have a sectional shape of a curved surface such as a substantially oval spherical surface. The convex portion 18 has an arc sectional shape that corresponds to substantially a half of the substantially oval spherical shape, for example.

As shown in FIG. 4B, the respective convex portions 16 are provided so as to correspond to the pixels P. Therefore, the convex portions 16 are aligned in a matrix arrangement in the display region E so as to overlap the respective concave portions 12 in plan view. An arrangement pitch of the convex portions 16 in the X direction and the Y direction is substantially the same as the arrangement pitch of the concave portions 12 in the X direction and the Y direction. In this embodiment, the convex portions 16 that are adjacent in the X direction and the Y direction are in contact with each other, and the arrangement pitch of the convex portions 16 in the X direction and the Y direction is the same as the diameter D1 of the convex portions 16.

The convex portions 17 and the convex portion 18 are provided in the parting region BS. The convex portions 17 are arranged in a line so as to surround the convex portions 16 that are aligned in the matrix arrangement. In other words, the convex portions 17 are arranged in a line in each of the X direction and the Y direction in the periphery of the display region E. The arrangement pitch of the convex portions 17 is substantially the same as the arrangement pitch (D1) of the convex portions 16. A diameter D2 of the convex portions 17 in the X direction and the Y direction is smaller than the diameter D1 of the convex portions 16. The diameter D2 of the convex portions 17 is smaller than the diameter D1 of the convex portions 16 by about 4% to about 6%, for example.

The convex portion 18 is provided in a frame shape in the periphery of the convex portions 17 that are arranged in a line in each of the X direction and the Y direction. In other words, the convex portion 18 has a planar shape in which a pair of portions that extend in the X direction and a pair of portions that extend in the Y direction are connected to each other. The portions of the convex portion 18 that extend in the X direction and the portions of the convex portion 18 that extend in the Y direction have the same width W. The width W of the portions that extend in the X direction and the portions that extend in the Y direction of the convex portion 18 is equal to or less than ½ of the arrangement pitch of the convex portions 16.

Returning to FIG. 4A, the second lens layer 15 is formed of a base lens layer 15a and the superficial lens layer 15b from the side of the intermediate layer 14. The base lens layer 15a includes a plurality of convex portions 16a, convex portions 17a that are arranged in a line in the periphery of the convex portions 16a, and a convex portion 18a that is arranged in a frame shape in the periphery of the convex portions 17a. In addition, it is possible to substantially ignore refraction and reflection of light that is incident on the second lens layer 15 at the boundary between the base lens layer 15a and the superficial lens layer 15b.

The convex portions 16, the convex portions 17, and the convex portion 18 of the second lens layer 15 (superficial lens layer 15b) are formed in such a manner that the shapes of the convex portions 16a, the convex portions 17a, and the convex portion 18a are enlarged, by laminating the superficial lens layer 15b on the base lens layer 15a. Therefore, the diameter of the convex portions 16a is smaller than the diameter D1 of the convex portions 16, the diameter of the convex portions 17a is smaller than the diameter D2 of the convex portions 17, and the width of the convex portion 18a is smaller than the width W of the convex portion 18.

The second lens layer 15 (superficial lens layer 15b) includes a flattened section 19, the height of which from the intermediate layer 14 is lower than the height of the convex portion 18, which has a substantially flat surface, outside the convex portion 18. In FIG. 4B, the region with the hatched lines directed toward the lower left side corresponds to a region in which the flattened section 19 is provided. The flattened section 19 is provided at the peripheral edge of the second lens layer 15 so as to surround the convex portion 18 in the frame shape.

When the height of the uppermost portion of the convex portion 18 with respect to the bottom between the convex portions 17 and the convex portion 18 is assumed to be H1 and the level difference between the uppermost portion of the convex portion 18 and the flattened section 19 is assumed to be H2 as shown in FIG. 4A, the level difference H2 is smaller than ½ of the height H1 of the convex portion 18, for example. In other words, the height of the flattened section 19 from the intermediate layer 14 is greater than ½ of the height H1 of the convex portion 18. In this embodiment, the height H1 of the convex portion 18 is substantially the same as the height of the convex portions 16 and the convex portions 17.

The base lens layer 15a includes a flattened section 19a with a substantially flat surface in the periphery of the convex portion 18. The flattened section 19 of the second lens layer 15 (superficial lens layer 15b) is formed so as to reflect the flattened section 19a by laminating the superficial lens layer 15b on the base lens layer 15a.

The second lens layer 15 (the base lens layer 15a and the superficial lens layer 15b) includes substantially the same optical refraction index as that of the first lens layer 13, for example, and is formed of the same material as that of the first lens layer 13. The base lens layer 15a and the superficial lens layer 15b are formed of the same material and have the same optical refraction index.

The optical path length adjustment layer 32 is formed so as to fill between the convex portions 16, between the convex portions 16 and the convex portions 17, between the convex portions 17 and the convex portion 18, and the flattened section 19, cover the second lens layer 15 (superficial lens layer 15b), and be thicker than the height H1 of the convex portion 18. The optical path length adjustment layer 32 has a light transmitting property and is made of an inorganic material with a lower optical refraction index than that of the second lens layer 15, for example. As such an inorganic material, SiO₂ is exemplified.

The second microlenses ML2 with the convex shape that are curved toward the opposite side (the side of the liquid crystal layer 40 shown in FIG. 3) to the substrate 11 are configured by covering the convex portions 16 with the optical path length adjustment layer 32. The respective second microlenses ML2 are provided so as to correspond to the pixels P. The plurality of second microlenses ML2 configure a microlens array in the second stage. Light that is incident on the optical path length adjustment layer 32 from each second microlens ML2 is collected toward the side of the center of each second microlens ML2 due to a difference in optical refraction indexes of the second lens layer 15 and the optical path length adjustment layer 32 (positive refractive power).

In addition, dummy microlenses MLd with a convex shape that are curved toward the opposite side to the substrate 11 are configured by covering the convex portions 17 with the optical path length adjustment layer 32. The dummy microlenses MLd are for suppressing variations in shapes of the second microlenses ML2 that are arranged in the display region E as will be described later. The dummy microlenses MLd are arranged in the parting region BS so as to overlap the light shielding portion 31 in plan view. Therefore, light that is incident on the dummy microlenses MLd is not transmitted through the microlens array substrate. For this reason, the dummy microlenses MLd do not contribute to display of the liquid crystal device 1.

The optical path length adjustment layer 32 has a function of adjusting the distance from the second microlenses ML2 to the light shielding portion 26 (see FIG. 3) to a desired value. Therefore, the thickness of the optical path length adjustment layer 32 is appropriately set based on optical conditions such as a focal distance of the second microlenses ML2 in accordance with a wavelength of light and the like.

The optical path length adjustment layer 32 is formed of a first optical path length adjustment layer 32a and a second optical path length adjustment layer 32b that are laminated from the side of the second lens layer 15. The first optical path length adjustment layer 32a has a substantially flat surface. The first optical path length adjustment layer 32a has a slit 33 that extends from a valley portion (boundary) between adjacent second microlenses ML2 to the side of the liquid crystal layer 40 (see FIG. 3). The slit 33 is provided so as to surround the second microlenses ML2 in plan view.

The slit 33 sections the first optical path length adjustment layer 32a into portions that correspond to the respective second microlenses ML2. The materials of the adjacent first optical path length adjustment layers 32a that are sectioned by the slit 33 do not have a bonded relationship while being in contact with each other. Therefore, the slit 33 functions as an interface between the materials of the adjacent first optical path length adjustment layers 32a, and light that is incident on the slit 33 is reflected.

The second optical path length adjustment layer 32b is formed so as to be laminated on the first optical path length adjustment layer 32a. The second optical path length adjustment layer 32b has a substantially flat surface. The slit 33 discontinues at the boundary between the first optical path length adjustment layer 32a and the second optical path length adjustment layer 32b. Therefore, the second optical path length adjustment layer 32b does not have the slit 33.

Returning to FIG. 3, the liquid crystal device 1 according to the embodiment is configured such that light that is generated by a light source, for example, is incident form the side of the facing substrate 30 (substrate 11) provided with the microlens array substrate 10. Light L1, which is incident on the center of each first microlens ML1 in the normal direction of the surface of the facing substrate 30 (substrate 11), as a portion of incident light travels straight, is incident on the center of each second microlens ML2, directly travels straight, is transmitted through the opening region T of each pixel P, and is then output to the side of the element substrate 20.

In the following description, the normal direction of the surface of the facing substrate 30 (substrate 11) will simply be referred to as a “normal direction”. The “normal direction” is a direction along the Z direction in FIG. 3, and is substantially the same as the normal direction of the element substrate 20 (substrate 21).

Light L2 that is incident on an end of each first microlens ML1 in the normal direction is blocked by the light shielding portion 26 as represented by the broken line if the light L2 directly travels straight. However, the light L2 is refracted toward the side of the center of the first microlens ML1 due to the difference in the optical refraction indexes of the substrate 11 and the first lens layer 13 (positive refractive power) and is then incident on each second microlens ML2. Then, the light L2 that is incident on the second microlens ML2 is further refracted toward the center of the second microlens ML2 due to the difference in the optical refraction indexes of the second lens layer 15 and the optical path length adjustment layer 32 (positive refractive power), is transmitted through the opening region T of each pixel P, and is then output to the side of the element substrate 20.

Light L3 that is incident on the end of each first microlens ML1 obliquely with respect to the normal direction and is incident toward the outside of the center of the first microlens ML1 is deviated toward the outside of the second microlens ML2 if the light L3 directly travels straight. However, the light L3 is refracted toward the side of the center due to the first microlens ML1 and is then incident on the second microlens ML2. The light L3 that is incident on the second microlens ML2 is blocked by the light shielding portion 26 if the light L3 directly travels straight. However, the light L3 is further refracted toward the side of the center of the second microlens ML2, is transmitted through the opening region T of each pixel P, and is then output to the side of the element substrate 20.

Light L4 that is incident on the end of the first microlens ML1 obliquely with respect to the normal direction and is incident toward the center from the outside of the first microlens ML1 is further inclined with respect to the normal direction due to refraction, intersects a line (represented by a one-dotted chain line in FIG. 3) that connects the center of the first microlens ML1 and the center of the second microlens ML2, and is then incident on the second microlens ML2. The light L4 that is incident on the second microlens ML2 is blocked by the light shielding portion 26 if the light L4 directly travels straight. However, the light L4 is refracted by the second microlens ML2, is returned to the side of the center, is less inclined with respect to the normal direction, is transmitted through the opening region T of the pixel P, and is then output to the side of the element substrate 20.

Light L5 that is incident on the end of the first microlens ML1 while being further inclined with respect to the normal direction and is incident from the center of the first microlens ML1 toward the outside is output from the end of the second microlens ML2 though the light L5 is refracted by the first microlens ML1 and the second microlens ML2 toward the side of the center due to insufficient refraction. The light L5 that is output from the second microlens ML2 is blocked by the light shielding portion 26 if the light L5 directly travels straight. However, the light L5 is reflected by the slit 33, is transmitted through the opening region T of the pixel P, and is then output to the side of the element substrate 20.

Light L6 that is incident on the end of the first microlens ML1 while being further inclined with respect to the normal direction in the same manner as the light L5 and is incident from the outside of the first microlens ML1 toward the center is further inclined with respect to the normal direction, intersects a line (represented by a one-dotted chain line in FIG. 3) that connects the center of the first microlens ML1 and the second microlens ML2, and is then incident on the end of the second microlens ML2. The light L6 that is output from the second microlens ML2 is deviated toward the side of next pixel P if the light L6 is insufficiently refracted and directly travels straight. However, the light L6 is reflected by the slit 33, is transmitted through the opening region T of the pixel P, and is then output to the side of the element substrate 20.

According to the liquid crystal device 1, it is possible to refract the light L2, the light L3, and the light L4, which are blocked in the light shielding region S in a case of directly traveling straight, to the side of the center of the opening region T of the pixel P due to effects of the first microlens ML1 and the second microlens ML2 provided in the two stages, and to transmit the light L2, the light L3, and the light L4 through the opening region T as described above. In addition, it is possible to refract the light L5 that is blocked in the light shielding region S even after being refracted by the first microlens ML1 and the second microlens ML2 in the two stages and the light L6 that is deviated to the side of the next pixel P to the side of the center of the opening region T of the pixel P due to an effect of the slit 33 and to transmit the light L5 and the light L6 through the opening region T. As a result, it is possible to increase the intensity of light that is output from the side of the element substrate 20 and to thereby enhance the efficiency of utilizing the light.

Although the embodiment is configured such that the optical refraction index of the optical path length adjustment layer 32 is lower than the optical refraction index of the second lens layer 15, another configuration is also applicable in which the optical refraction index of the optical path length adjustment layer 32 is higher than the optical refraction index of the second lens layer 15. With such a configuration, the light that is incident o the second microlens ML2 is diffused from the center of the second microlens ML2 toward the outside due to the difference in the optical refraction indexes of the second lens layer 15 and the optical path length adjustment layer 32 (negative refractive power). Therefore, it is possible to reduce an angle of the light that is collected by the first microlens ML1 and is inclined with respect to the normal direction by the second microlens ML2 and to cause the angle to approach the normal direction.

If the liquid crystal device 1 is used as a liquid crystal light valve in a projector and a large part of light that is output from the liquid crystal device 1 is inclined with respect to the normal direction, an uptake angle of a projection lens is exceeded, vignetting occurs, and as a result, the efficiency of utilizing the light deteriorates in some cases. In such cases, a configuration is applicable in which the second microlenses ML2 have negative refractive power.

Although the embodiment is configured such that the light shielding portion 31 is provided in the frame shape in the parting region BS, the light shielding portion 31 may have, in addition to the frame-shaped portion, a grid-shaped portion that overlaps the light shielding portion 22 and the light shielding portion 26 (see FIG. 3) of the element substrate 20 in plan view in order to suppress light being incident on the TFTs 24. However, the first optical path length adjustment layer 32a is provided with the slit 33 in the liquid crystal device 1, and it is possible to reflect light, which is insufficiently refracted by the first microlens ML1 and the second microlens ML2 and travels toward the outside of the opening region T, by the slit 33, to cause the light to be incident on the opening region T, and to thereby sufficiently suppress the light being incident on the TFTs 24.

Furthermore, although the embodiment is configured such that the dummy microlenses MLd are provided only on the side of the second microlenses ML2 (second lens layer 15), another configuration is also applicable in which the dummy microlenses are also provided on the side of the first microlenses ML1.

### Method of Manufacturing Microlens Array Substrate

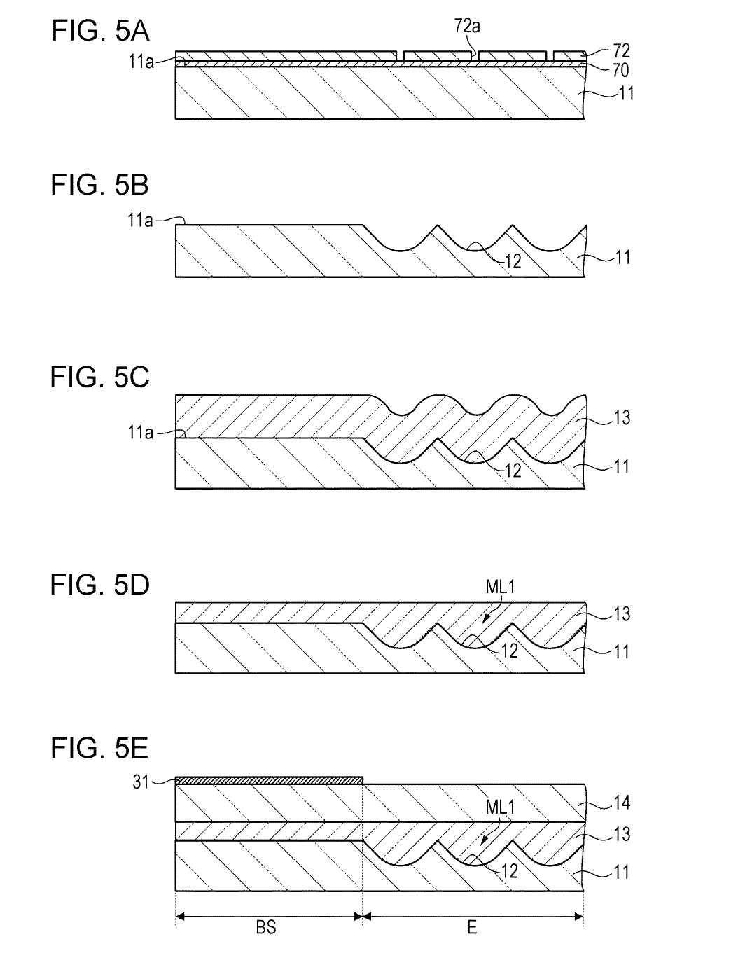

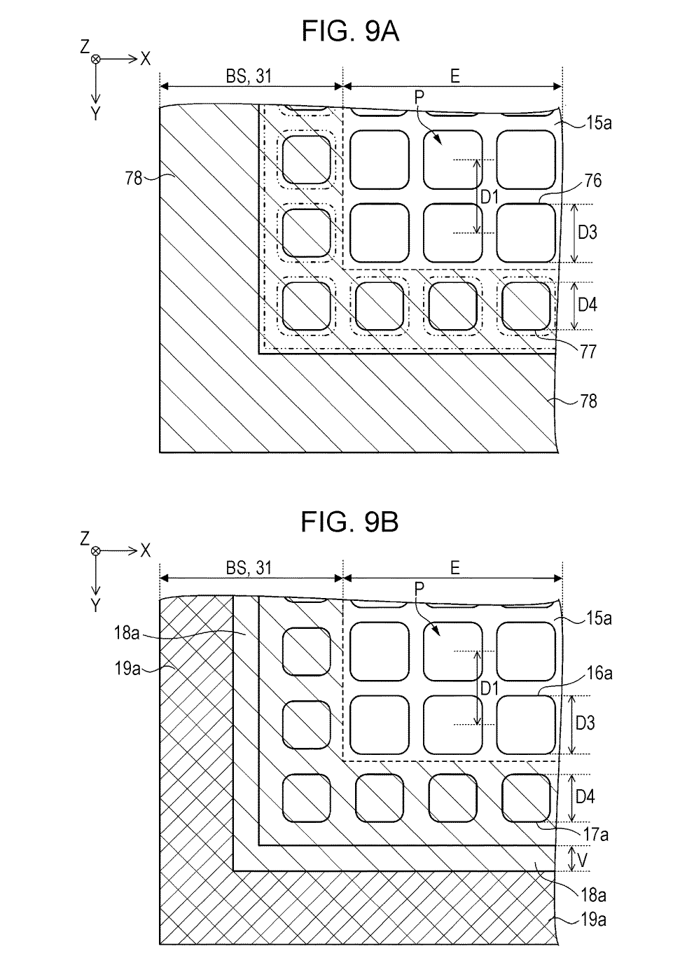

Next, a description will be given of a method of manufacturing the microlens array substrate 10 according to the embodiment. FIGS. 5A to 9B are diagrams schematically showing the method of manufacturing the microlens array substrate according to the embodiment. Each of FIGS. 5A to 8C corresponds to the sectional view schematically shown in FIG. 4A. In addition, FIGS. 9A and 9B correspond to the plan view schematically shown in FIG. 4B.

As shown in FIG. 5A, a control film 70 that is made of an oxide film of SiO₂, for example, is formed on the surface 11a of the light transmitting substrate 11 that is made of quartz, for example. The control film 70 is obtained by isotropic etching at a different etching rate from that for the substrate 11 and has a function of adjusting an etching rate in width directions (the X direction and the Y direction shown in FIG. 4B) with respect to an etching rate in a depth direction (Z direction) when the concave portions 12 are formed.

After the control film 70 is formed, the control film 70 is annealed at a predetermined temperature. The etching rate of the control film 70 varies depending on the temperature during the annealing. Therefore, it is possible to adjust the etching rate of the control film 70 by appropriately setting the temperature during the annealing.

Next, a mask layer 72 is formed on the control film 70. Then, the mask layer 72 is patterned, and opening 72a are formed in the mask layer 72. The positions of the centers of the openings 72a in a plane correspond to the centers of the formed concave portions 12. Subsequently, the substrate 11 that is covered with the control film 70 is subjected to isotropic etching via the openings 72a in the mask layer 72. Though not shown in the drawing, openings are formed in regions at which the openings overlap the openings 72a in the control film 70 are formed, and the substrate 11 is etched via the openings in this isotropic etching.

For the isotropic etching, such an etching solution (such as hydrofluoric acid solution) that the etching rate of the control film 70 becomes greater than the etching rate of the substrate 11 is used. In doing so, the amount of etching of the control film 70 per unit time becomes larger than the amount of etching of the substrate 11 per unit time in the isotropic etching. Therefore, the amounts of etching of the substrate 11 in the width directions become larger than the amount of etching in the depth direction with enlargement of the openings formed in the control film 70.

The control film 70 and the substrate 11 are etched from the openings 72a in the isotropic etching, and the concave portions 12 are formed on the side of the surface 11a of the substrate 11 as shown in FIG. 5B. By setting the etching rates as described above, the concave portions 12 are enlarged in the width directions than in the depth direction, and tapered oblique surfaces are formed in the peripheral edges of the concave portions 12. FIG. 5B shows a state after the mask layer 72 and the control film 70 are removed.

In this process, the isotropic etching is performed until the concave portions 12 that are adjacent in the X direction and the Y direction are connected to each other. In addition, it is preferable that the isotropic etching is completed in a state in which the concave portions 12 that are adjacent in a diagonal line direction that intersects the X direction and the Y direction are separate from each other, that is, a state in which the surface 11a of the substrate 11 remains at each gap between the concave portions 12 that are adjacent in the diagonal line direction.

If the isotropic etching is performed until the concave portions 12 that are adjacent in the diagonal line direction are connected to each other, there is a concern that the mask layer 72 floats from the substrate 11 and peels off. If the isotropic etching is completed in the state in which the surface 11a of the substrate 11 remains at the gap between the adjacent concave portions 12, it is possible to support the mask layer 72 until the isotropic etching is completed. In doing so, the planar shape of each concave portion 12 becomes a substantially rectangular shape with four rounded corners (see FIG. 4B).

Although the concave portions 12 including the tapered oblique surfaces at the peripheral edges are formed in the embodiment, the concave portions 12 may be formed so as to be entirely formed of curved surfaces without any tapered oblique surfaces at the peripheral edges thereof. In such a case, the control film 70 may not be provided when the concave portions 12 are formed.

Next, the first lens layer 13 is formed by depositing a light transmitting inorganic material with a higher optical refraction index than that of the substrate 11 so as to cover the substrate 11 on the side of the surface 11a and fill the concave portions 12 as shown in FIG. 5C. The first lens layer 13 can be formed by using the CVD method, for example. Since the first lens layer 13 is formed so as to fill the concave portions 12, the first lens layer 13 has a surface with unevenness that reflects unevenness caused by the concave portions 12 in the substrate 11.

In addition, an alignment mark for positioning the first microlenses ML1 and the second microlenses ML2 and positioning the microlens array substrate 10 (facing substrate 30) and the element substrate 20 may be formed between the substrate 11 and the first lens layer 13. The alignment mark is arranged in the parting region BS in which the light shielding portion 31 is formed in the process shown in FIG. 5E.

Next, the first lens layer 13 is subjected to flattening processing as shown in FIG. 5D. In the flattening processing, an upper surface is flattened by polishing and removing portions, in which unevenness is formed, on the upper side of the first lens layer 13 by using chemical mechanical polishing (CMP) processing, for example. Then, the first microlenses ML1 are configured by filling the concave portions 12 with the material of the first lens layer 13.

Next, the intermediate layer 14 is formed by depositing a light transmitting inorganic material with substantially the same optical refraction index as that of the substrate 11, for example, so as to cover the first lens layer 13 as shown in FIG. 5E. The intermediate layer 14 may be formed by using the CVD method, for example. Then, the light shielding portion 31 is formed of metal such as aluminum (Al) or metal oxide on the intermediate layer 14. The light shielding portion 31 is formed in a frame shape in the periphery of the region in which the concave portions 12 are formed. The region that overlaps the light shielding portion 31 in plan view corresponds to the parting region BS, and the region that is surrounded by the parting region BS corresponds to the display region E.

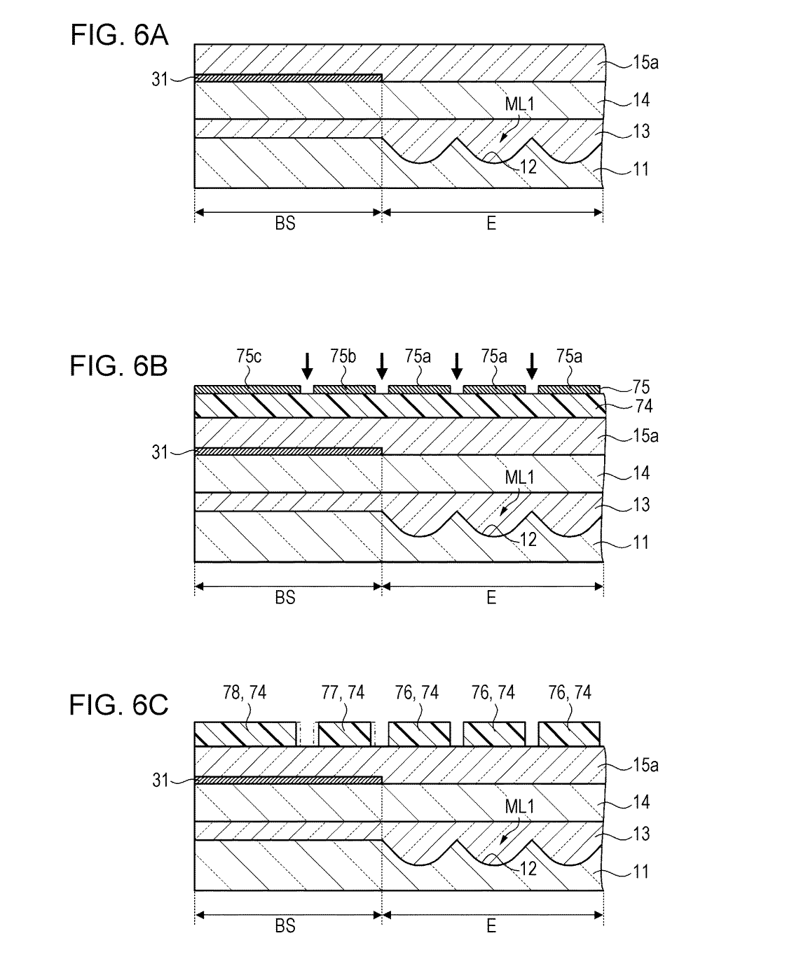

Next, the base lens layer 15a is formed by depositing a light transmitting inorganic material with a higher optical refraction index than that of the substrate 11 so as to cover the intermediate layer 14 and the light shielding portion 31 as shown in FIG. 6A. The base lens layer 15a can be formed by using the CVD method, for example.

Next, a resist layer 74 as a photosensitive material layer is formed on the base lens layer 15a as shown in FIG. 6B. The resist layer 74 is formed of positive-type photosensitive resist, an exposed portion of which is removed by development, for example. The resist layer 74 can be formed by the spin coating method or the roll coating method, for example. Then, the resist layer 74 is exposed to light and development is performed via the mask 75 in which light shielding portions 75a, 75b, and 75c are provided so as to correspond to the respective positions at which the convex portions 16, the convex portions 17, and the convex portion 18 are formed. In the mask 75, the size of each light shielding portion 75a corresponding to each convex portion 16 (diameters in the X direction and the Y direction) is the same as the size of each light shielding portion 75b corresponding to each convex portion 17.

As shown by the arrow in FIG. 6B, the resist layer 74 is exposed to light by irradiating the mask 75 with exposure light from the upper side, and the development is performed (patterning process). In doing so, as shown in FIG. 6C, a region other than the regions, which overlap the light shielding portions 75a, 75b, and 75c of the mask, in the resist layer 74 is exposed to light and is then removed, and the portions that overlap the light shielding portions 75a, 75b, and 75c respectively remain in island shapes. That is, the resist layer 74 is patterned, and portions 76 as the first island-shaped sections, portions 77 as the second island-shaped sections, and a portion 78 as the frame-shaped section are formed.

FIG. 9A is a plan view in the state of FIG. 6C after the patterning is performed on the resist layer 74. As shown in FIG. 9A, the portions 76, the portions 77, and the portion 78 are formed on the base lens layer 15a. The portions 76 are separate from each other in the X direction, the Y direction, and the diagonal line direction, the portions 77 are separate from each other in the X direction, the Y direction, and the diagonal line direction, and the portions 76, the portions 77, and the portion 78 are separate from each other in the X direction, the Y direction, and the diagonal line direction. The portions 76, the portions 77, and the portion 78 correspond to the convex portions 16, the convex portions 17, and the convex portion 18, which will be formed in the process performed later, respectively.

The portions 76 are aligned in a matrix arrangement at the same arrangement pitch as the arrangement pitch (D1) of the convex portions 16 in the X direction and the Y direction. The portions 77 are aligned in a line in the periphery of the portions 76 at the same arrangement pitch as that of the portions 76. The portion 78 is arranged in a frame shape in the periphery of the portions 77.

The planar shapes of the portions 76 and the portions 77 are substantially rectangular shapes, each of which has four rounded corners. As a method of rounding the four corners of each of the portions 76 and the portions 77, the four corners may be mounted in the mask when the resist layer 74 is exposed to light, or the four corners may be rounded from a rectangular state in the mask when the resist layer 74 is exposed to light. The planar shape of the portion 78 is a frame shape in which a pair of portions that extend in the X direction and a pair of portions that extend in the Y direction are connected to each other.

Incidentally, the light with which the resist layer 74 is irradiated is transmitted to the side of the substrate 11 in the display region E in the process of exposing the resist layer 74 to light. In contrast, the light with which the resist layer 74 is irradiated is blocked by the light shielding portion 31 in the parting region BS shown with hatched lines directed toward the lower right side in FIG. 9A since the light shielding portion 31 is arranged between the base lens layer 15a and the intermediate layer 14. However, light reflected by the light shielding portion 31 is returned to the side of the resist layer 74. Therefore, the amount of exposure light at a portion, which overlaps the light shielding portion 75b, of the resist layer 74 is larger than the amount of exposure light at a portion which overlaps the light shielding portion 75a.

Therefore, a diameter D4 of the portions 77, which overlap the light shielding portion 75b and remain, in the X direction and the Y direction is smaller than a diameter D3 of the portions 76, which overlap the light shielding portion 75a and remain, in the X direction and the Y direction. The diameter D4 of the portions 77 is smaller than the diameter D3 of the portions 76 by about 4% to about 6%, for example. Since the amount of exposure light at a portion that overlap the light shielding portion 75c also increases, the size of the remaining portion 78 also decreases. FIG. 9A shows outlines of the portions 77 and the portion 78 by two-dotted chain lines in a case in which no light is reflected by the light shielding portion 31, for comparison.

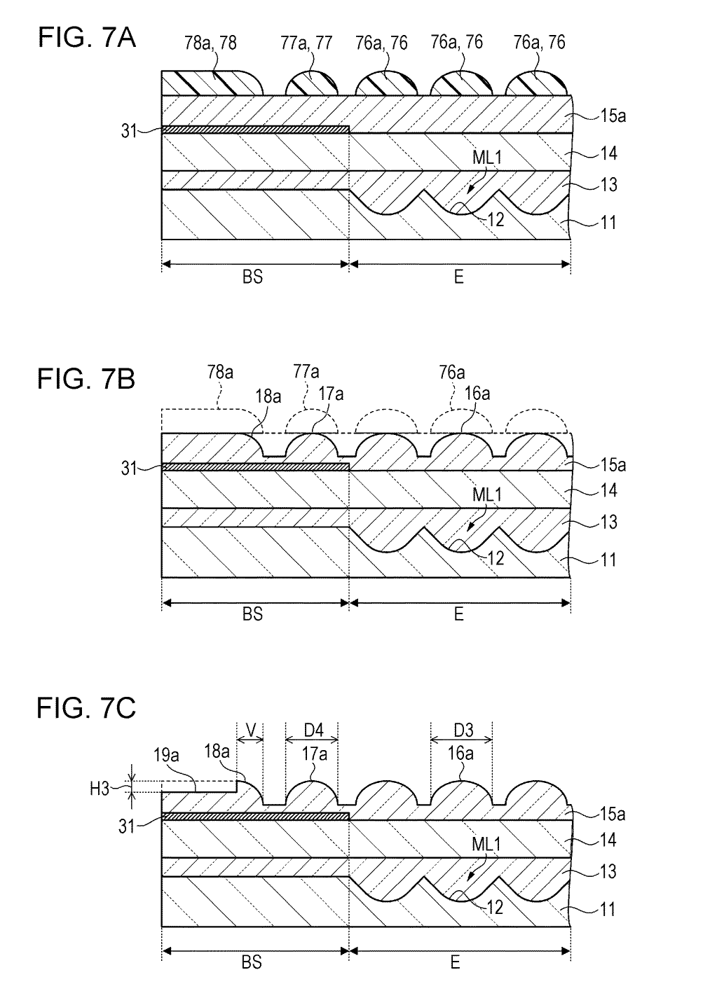

Next, the remaining portions 76, 77, and 78 in the resist layer 74 are softened (melted) by heat treatment such as reflow processing as shown in FIG. 7A. The melted portions 76, 77, and 78 are brought into a fluidized state, and the surfaces thereof are deformed into curved surfaces due to an effect of surface tension. In doing so, convex portions 76a, 77a, and 78a with substantially oval spherical shapes are formed from the remaining portions 76, 77, and 78 on the base lens layer 15a. The convex portions 76a, 77a, and 78a have substantially concentric circle shapes in plan view on the side of tip ends of the substantially spherical shapes while the convex portions 76a, 77a, and 78a have substantially rectangular shapes with four rounded corners in plan view on the side of the bottoms thereof (the side of the base lens layer 15a).

In the process shown in FIG. 6B, the convex portions 76a, 77a, and 78a as shown in FIG. 7A may be processed from the resist layer 74 by performing an exposure method using a gray scale mask or an area gradation mask or a multi-stage exposure method, for example, on the resist layer 74.

Next, anisotropic etching such as dry etching is performed on the convex portions 76a, 77a, and 78a and the base lens layer 15a from the upper side as shown in FIG. 7B (etching process). By the etching process, the convex portions 76a, 77a, and 78a formed of resist are gradually removed, and exposed portions of the base lens layer 15a are etched and removed as the convex portions 76a, 77a, and 78a are removed.

After the convex portions 76a, 77a, and 78a are entirely removed, the respective shapes of the convex portions 76a, 77a, and 78a are transferred to the base lens layer 15a, and the convex portions 16a, 17a, and 18a are formed. In this process, the respective shapes of the formed convex portions 16a, 17a, and 18a can be substantially the same as the respective shapes of the convex portions 76a, 77a, and 78a under such a condition that enables the etching rate of the material (resist) of the convex portions 76a, 77a, and 78a to be substantially the same as the etching rate of the material of the base lens layer 15a in the anisotropic etching.

In the etching process, the convex portions 16a for configuring the second microlenses ML2 are formed by etching the base lens layer 15a along the convex portions 76a that are shaped into convex portions by patterning the resist layer 74. Therefore, each of the plurality of convex portions 16a formed in the display region E is formed under influences of the convex portions 16a in the periphery thereof.

In a case in which only the convex portions 16a are formed and the convex portions 17a are not formed in the periphery thereof, the convex portions 16a that are formed in the outermost periphery in the display region E in the etching process do not have adjacent convex portions 16a on one side (outer side). Therefore, the amount of removal of the base lens layer 15a in the etching process increases for the convex portions 16a formed in the outermost periphery than for the convex portions 16a around which adjacent convex portions 16a are present, and differences in shapes occurs. As a result, variations in the properties occur between the second microlenses ML2 in the outermost periphery and the other second microlenses ML2 positioned inside the second microlenses ML2 in the outermost periphery.

Thus, the occurrence of the differences in shapes of the second microlenses ML2 (convex portions 16a) in the display region E is avoided by arranging the dummy microlenses MLd (convex portions 17a) that do not contribute to display in the periphery of the second microlenses ML2 (convex portions 16a) that contribute to display in this embodiment. In addition, the differences in shapes of the second microlenses ML2 (convex portions 16a) in the display region E can be further suppressed by arranging the convex portion 18a in the frame shape in the periphery of the dummy microlenses MLd (convex portions 17a).

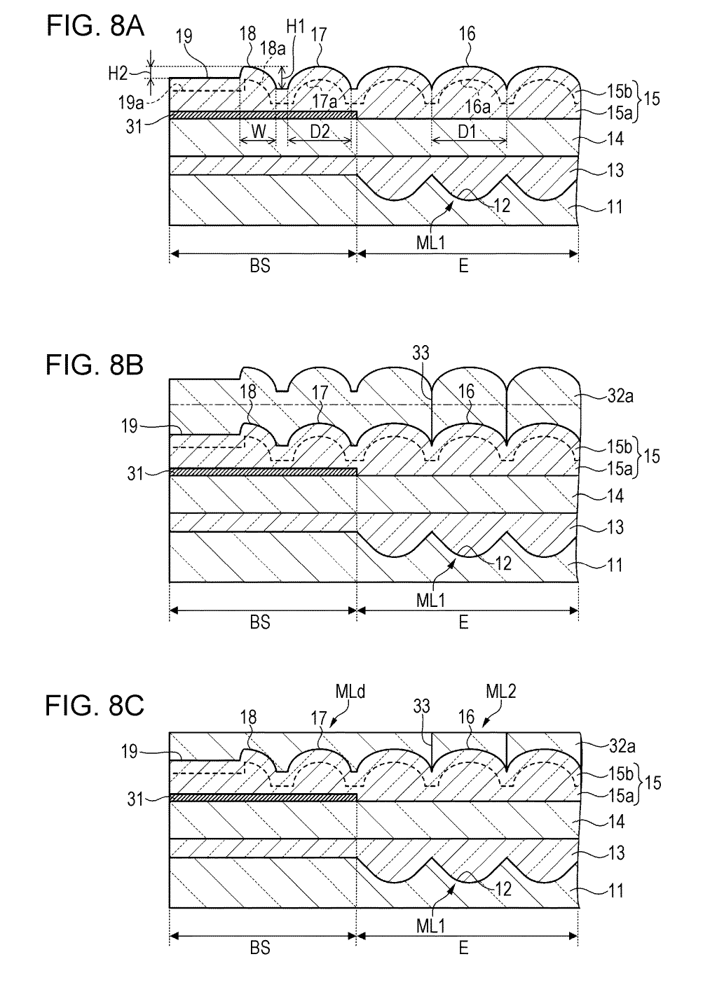

In the embodiment, the dummy microlenses MLd (convex portions 17a) that are arranged in the periphery of the second microlenses ML2 (convex portions 16a) are aligned only in one line in each of the X direction and the Y direction in order to reduce the number of processes in the flattening processing for flattening the surface of the optical path length adjustment layer 32 that is formed in a process performed later. This will be described later with reference to the processes in the flattening processing shown in FIG. 8C.

Next, the peripheral edge of the convex portion 18a in the base lens layer 15a is removed by a predetermined thickness from the side of the surface, and the flattened section 19a with a substantially flat surface is formed as shown in FIG. 7C. As a method of forming the flattened section 19a, a region other than the region, in which the flattened section 19a is formed, in the base lens layer 15a is covered with a protection member, and anisotropic etching such as dry etching is performed on the base lens layer 15a.

FIG. 9B is a plan view of the base lens layer 15a in a state after the process shown in FIG. 7C is performed. The planer shapes of the convex portions 16a and the convex portions 17a shown in FIG. 9B are obtained by transferring the planar shapes of the portions 76 and the portions 77 after the patterning process shown in FIG. 9A is performed. The outside of the convex portion 18a is etched and removed while the inside portion thereof with a width V in the portions extending in the X direction and the portions extending in the Y direction in the frame shape is made to remain. The width V of the remaining convex portion 18a is appropriately set such that the width W of the convex portion 18 that is formed by laminating the superficial lens layer 15b on the base lens layer 15a in the following process shown in FIG. 8A becomes equal to or less than ½ of the arrangement pitch of the convex portions 16.

If the predetermined thickness (depth) by which the base lens layer 15a is removed from the side of the surface of the convex portion 18a for forming the flattened section 19a is assumed to be H3, a level difference H3 is formed between the formed flattened section 19a and the uppermost portion of the convex portion 18a as shown in FIG. 7C. The level difference H3 is appropriately set such that a level difference H2 between the flattened section 19 that is formed by laminating the superficial lens layer 15b on the base lens layer 15a in the following process shown in FIG. 8A and the uppermost portion of the convex portion 18 is smaller than ½ of the height H1 of the convex portion 18.

The flattened section 19a is formed for the purpose of reducing the number of the flattening processing for flattening the surface of the optical path length adjustment layer 32 that is formed in the process performed later. This will also be described with reference to the processes in the flattening processing shown in FIG. 8C.

Next, the superficial lens layer 15b is laminated and formed on the base lens layer 15a as shown in FIG. 8A. The superficial lens layer 15b is formed of the same material as that of the base lens layer 15a by the same method as that of the base lens layer 15a. The laminated base lens layer 15a and the superficial lens layer 15b configure the second lens layer 15. As described above, refraction and reflection of light at the boundary between the base lens layer 15a and the superficial lens layer 15b can be substantially ignored.

The convex portions 16, 17, and 18 are formed in enlarged states of the convex portions 16a, 17a, and 18a on the surface of the second lens layer 15 (superficial lens layer 15b) by laminating the superficial lens layer 15b so as to cover the convex portions 16a, 17a, and 18a in the base lens layer 15a. As a result, the convex portions 16 that are adjacent in the X direction and the Y direction are connected to each other.

Another configuration is also applicable in which the base lens layer 15a and the superficial lens layer 15b are formed of materials with different optical refraction indexes. In the case of employing such a configuration, light is refracted between the base lens layer 15a and the superficial lens layer 15b. It is also possible to enhance the efficiency of utilizing the light by collecting or diffusing incident light by utilizing the refraction of the light.

Next, the first optical path length adjustment layer 32a is formed by depositing a light transmitting inorganic material with an optical refraction index difference from that of the second lens layer 15 so as to cover the second lens layer 15 as shown in FIG. 8B. The first optical path length adjustment layer 32a can be formed by using the CVD method, for example. The first optical path length adjustment layer 32a has a surface with an uneven shape that reflects unevenness caused by the convex portions 16, 17, and 18 of the second lens layer 15.

In this process, the first optical path length adjustment layer 32a is laminated, and the slit 33 is formed inside the first optical path length adjustment layer 32a. The first optical path length adjustment layer 32a grows so as to enlarge the shapes of the convex portions 16 of the second lens layer 15. Since the growth substantially uniformly proceeds from the convex portions 16 on both sides at a valley between the convex portions 16, directions of the growth on the both sides cross at a narrowed portion. The slit 33 as a boundary of the directions of the growth is formed at the crossing portion. The slit 33 grows in a laminated direction (Z direction) inside the first optical path length adjustment layer 32a.

Next, the flattening processing is performed on the first optical path length adjustment layer 32a as shown in FIG. 8C (processes in the flattening processing). In the processes of the flattening processing, an upper surface is flattened by polishing and removing a portion, in which unevenness is formed, on the upper side than the two-dotted chain line of the first optical path length adjustment layer 32a shown in FIG. 8B by using the CMP processing, for example. In the processes of the flattening processing, it is necessary to alleviate the level differences in the individual uneven shapes caused by the convex portions 16, 17, and 18 and to alleviate the level differences in a large range corresponding to the entire region including the display region E and the parting region BS.

Here, since the diameter D2 of the convex portions 17 is smaller than the diameter D1 of the convex portions 16 (see FIG. 8A), the density of the material of the first optical path length adjustment layer 32a per unit volume in the processes of the flattening processing differs between the display region E in which the convex portions 16 are arranged and the parting region BS in which the convex portions 17 are arrange. In addition, since the convex portions 17 have different shapes from that of the convex portion 18 that is arranged in the periphery thereof, a difference in the density of the material of the first optical path length adjustment layer 32a per unit volume in the parting region BS occurs.

In the case in which the convex portions 17 are arranged in a plurality of lines in the periphery of the convex portions 16 as disclosed in JP-A-11-202314, for example, the difference in the density of the material of the first optical path length adjustment layer 32a per unit volume further increases between the display region E in which the convex portions 16 are arranged and the region in which the convex portions 17 are arranged in the parting region BS.

For this reason, the density of the material of the first optical path length adjustment layer 32a per unit volume in the processes of the flattening processing differs in three levels in the display region E in which the convex portions 16 are arranged, in the region in which the convex portions 17 are arranged in the parting region BS, and the region in which the convex portion 18 is formed in the periphery of the convex portions 17 in the parting region BS. Therefore, the polishing amount of the first optical path length adjustment layer 32a increase and the number of processes in the flattening processing increases in order to alleviate the individual uneven shapes due to the convex portions 16, 17, and 18 and to alleviate the level differences in the large range of the entire region including the display region E and the parting region BS.

Since the convex portions 17 are arranged in a line in the periphery of the convex portions 16 in the embodiment, it is possible to reduce the difference in the density of the material of the first optical path length adjustment layer 32a per unit volume between the display region E in which the convex portions 16 are arranged and the region in which the convex portions 17 are arranged in the parting region BS as compared with the case in which the convex portions 17 are arranged in the plurality of lines. In doing so, it is possible to reduce the influence of the difference in the density in the region in which the convex portions 17 are arranged with respect to the difference in the density in the large range of the entire region including the display region E and the parting region BS.

In a case in which no convex portion 18 is provided in the periphery of the convex portions 17, a large level difference between the display region E and the parting region BS occurs on the surface of the first optical path length adjustment layer 32a that is formed on the second lens layer 15. Therefore, the number of processes in the flattening processing increases. Since the convex portion 18 is provided in the periphery of the convex portions 17 in the embodiment, it is possible to reduce the level difference between the display region E and the parting region BS on the surface of the first optical path length adjustment layer 32a as compared with the case in which no convex portion 18 is provided.

Furthermore, the convex portion 18 has the frame shape with the width W by forming the flattened section 19 in the peripheral edge of the convex portion 18. The continuing convex portion 18 is arranged so as to face the convex portions 17 aligned in a line at positions of the respective sides of the frame shape in the X direction and the Y direction. Therefore, it is possible to reduce the difference in the density of the material of the optical path length adjustment layer 32 per unit volume between the region in which the convex portions 17 are arranged and the region in which the convex portion 18 is arranged at the positions of the respective sides of the frame shape. That is, it is possible to reduce the difference in the density of the material of the optical path length adjustment layer 32 per unit volume in the entire parting region BS.

In doing so, it is possible to reduce the difference in the density of the material of the first optical path length adjustment layer 32a per unit volume between the display region E and the parting region BS as compared with the case in which no flattened section 19 is formed. In addition, the level difference H2 between the uppermost portion of the convex portion 18 and the flattened section 19 and the width W of the convex portion 18 are set so as to minimize the difference in the density of the material of the first optical path length adjustment layer 32a per unit volume between the display region E and the parting region BS.

As a result, it is possible to reduce the polishing amount of the first optical path length adjustment layer 32a in the processes of the flattening processing and to thereby reduce the number of processes according to the embodiment. In addition, it is possible to enhance flatness of the surface of the first optical path length adjustment layer 32a.

Next, the second optical path length adjustment layer 32b is laminated and formed on the first optical path length adjustment layer 32a as shown in FIG. 4A. The second optical path length adjustment layer 32b is formed by using the same material as that of the first optical path length adjustment layer 32a by the same method as that of the first optical path length adjustment layer 32a. In addition, the flattening processing is performed on the surface of the second optical path length adjustment layer 32b to further enhance the flatness of the surface. Since the second optical path length adjustment layer 32b is formed on the first optical path length adjustment layer 32a after the flattening processing, the slit 33 is not formed in an extended manner.

The laminated first optical path length adjustment layer 32a and the second optical path length adjustment layer 32b configure the optical path length adjustment layer 32. The second microlenses ML2 are configured by covering the convex portions 16 with the optical path length adjustment layer 32. In addition, the dummy microlenses MLd are configured by covering the convex portions 17 with the optical path length adjustment layer 32.

The microlens array substrate 10 is completed as described above. After the completion of the microlens array substrate 10, the facing substrate 30 is obtained by sequentially forming the common electrode 34 and the orientation film 35 on the microlens array substrate 10 by using a known technology as shown in FIG. 3. Then, the element substrate 20 is obtained by sequentially forming the light shielding portion 22, the insulating layer 23, the TFTs 24, the insulating layer 25, the light shielding portion 26, the insulating layer 27, the pixel electrodes 28, and the orientation film 29 on the substrate 21 by using a known method.

Subsequently, the element substrate 20 and the facing substrate 30 are positioned, a thermosetting or photo-curable adhesive is arranged as the sealing material 42 (see FIG. 1) between the element substrate 20 and the facing substrate 30 and is then cured to attach the substrates. Then, the liquid crystal device 1 is completed by sealing and interposing liquid crystal in spaces configured by the element substrate 20, the facing substrate 30, and the sealing material 42. The liquid crystal may be arranged in the region surrounded by the sealing material 42 before the element substrate 20 and the facing substrate 30 are attached to each other.

The liquid crystal device 1 according to the embodiment includes, on the facing substrate 30, the microlens array substrate 10 that includes two-stage microlens array, each of which is formed of the first microlens ML1 and the second microlens ML2, and has a surface with satisfactory flatness. Therefore, it is possible to enhance the efficiency of utilizing light, to further uniformize the gap between the element substrate 20 and the facing substrate 30, and to thereby provide the liquid crystal device 1 with bright display and excellent display quality.

### Electronic Apparatus

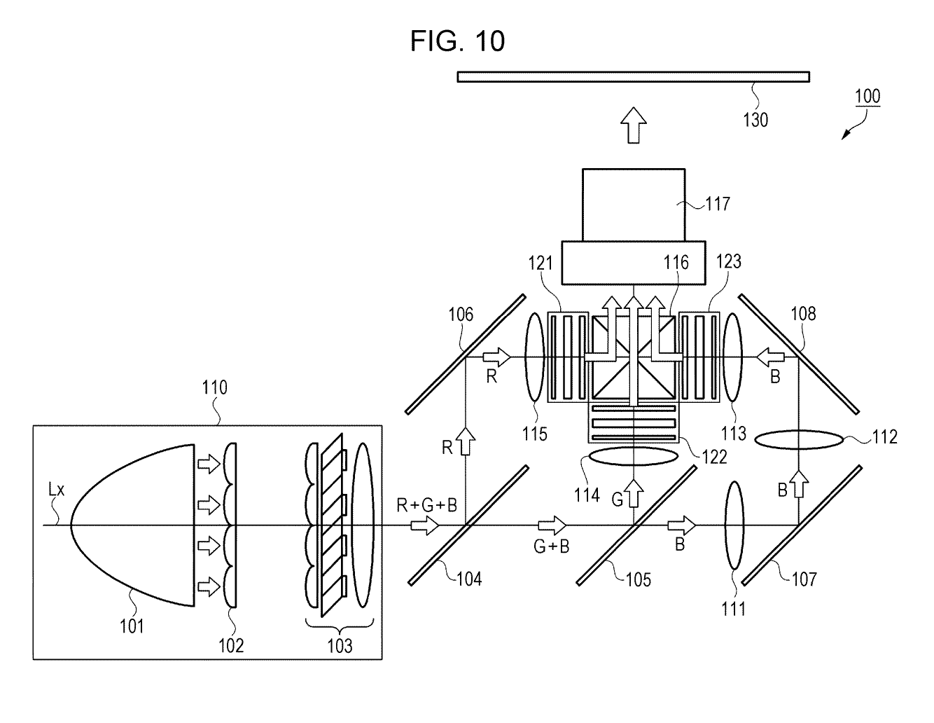

Next, a description will be given of an electronic apparatus according to the embodiment with reference to FIG. 10. FIG. 10 is a diagram schematically showing a configuration of a projector as the electronic apparatus according to the embodiment.

As shown in FIG. 10, a projector (projection-type display apparatus) 100 as the electronic apparatus according to the embodiment includes a polarized illumination device 110, two dichroic mirrors 104 and 105, three reflective mirrors 106, 107, and 108, five relay lenses 111, 112, 113, 114, and 115, three liquid crystal light valves 121, 122, and 123, a cross dichroic prism 116, and a projection lens 117.

The polarized illumination device 110 includes a lamp unit 101 as a light source formed of a white light source such as an ultrahigh pressure mercury lamp or a halogen lamp, an integrator lens 102, and a polarization conversion element 103. The lamp unit 101, the integrator lens 102, and the polarization conversion element 103 are arranged along an optical axis Lx of the system.

The dichroic mirror 104 reflects red light (R) and transmits green light (G) and blue light (B) therethrough from among polarized light fluxes output from the polarized illumination device 110. The other dichroic mirror 105 reflects the green light (G) that has been transmitted through the dichroic mirror 104 and transmits the blue light (B).

The red light (R) reflected by the dichroic mirror 104 is reflected by the reflective mirror 106 and is then incident on the liquid crystal light valve 121 via the relay lens 115. The green light (G) reflected by the dichroic mirror 105 is incident on the liquid crystal light valve 122 via the relay lens 114. The blue light (B) transmitted through the dichroic mirror 105 is incident on the liquid crystal light valve 123 via a light guiding system formed of the three relay lenses 111, 112, and 113 and the two reflective mirrors 107 and 108.

The light transmitting liquid crystal light valves 121, 122, and 123 as the light modulation elements are respectively arranged so as to face the incident surfaces of the cross dichroic prism 116 for light with the respective colors. The light that is incident on the liquid crystal light valves 121, 122, and 123 is modulated based on video information (video signal) and is output toward the cross dichroic prism 116.

The cross dichroic prism 116 is formed such that four right angle prisms are attached and a dielectric body multilayered film that reflects the red light and a dielectric body multilayered film that reflects the blue light are formed into a cross shape in the inner surface thereof. The light with the three colors is synthesized by these dielectric body multilayered films, and light representing a color image is synthesized. The synthesized light is projected to a screen 130 by the projection lens 117 as a projection optical system, and an image is displayed in an enlarged manner.

The liquid crystal light valve 121 is arranged between a pair of polarization elements, which are arranged in crossed nicols on the incident side and the output side of the color light, at an interval. The other liquid crystal light valves 122 and 123 are configured in the same manner. The liquid crystal device 1 according to the embodiment is applied to the liquid crystal light valves 121, 122, and 123.

According to the microlens array substrate 10, the liquid crystal device 1, the projector 100, and the method of manufacturing the microlens array substrate of the embodiment as described above, it is possible to achieve the following effects.

(1) Since the dummy microlenses MLd (convex portions 17) are arranged in a line in the periphery of the second microlenses ML2 (convex portions 16), it is possible to reduce the difference in the density of the material of the optical path length adjustment layer 32 per unit volume between the display region E in which the second microlenses ML2 are arranged and the parting region BS in which the dummy microlenses MLd are arranged as compared with the case in which the dummy microlenses MLd are arranged in a plurality of lines. In doing so, it is possible to enhance the flatness of the surface of the microlens array substrate 10 (optical path length adjustment layer 32). In addition, it is possible to reduce the number of processes in the flattening processing of the optical path length adjustment layer 32 in manufacturing the microlens array substrate 10 and to thereby enhance productivity of the microlens array substrate 10.

(2) Since the convex portion 18 is arranged in the periphery of the convex portions 17 of the second lens layer 15, it is possible to reduce the difference in the density of the material of the optical path length adjustment layer 32 per unit volume between the region in which the convex portions 17 are arranged in the parting region BS and the peripheral region in which the convex portion 18 is arranged. In doing so, it is possible to further enhance the flatness of the surface of the microlens array substrate 10 (optical path length adjustment layer 32). In addition, it is possible to further reduce the number of processes in the flattening processing of the optical path length adjustment layer 32 in manufacturing the microlens array substrate 10.

(3) Since the convex portion 18 is arranged in the frame shape in the periphery of the convex portions 17 that are arranged in a line, the convex portion 18 is arranged so as to face the convex portions 17 that are aligned in a line at the positions of the respective sides of the frame shape in the X direction and the Y direction. Therefore, it is possible to reduce the difference in the density of the material of the optical path length adjustment layer 32 per unit volume between the region in which the convex portions 17 are arranged and the region in which the convex portion 18 is arranged at the positions of the respective sides of the frame shape.

(4) The convex portions 17 are arranged at substantially the same arrangement pitch D1 in the X direction and the Y direction, and the width W of the convex portion 18, which is arranged in the frame shape in the periphery thereof, in the X direction and the Y direction is equal to or less than ½ of the arrangement pitch D1 of the convex portions 17. Therefore, since the continuing convex portion 18 with the width W that is equal to or less than ½ of the arrangement pitch D1 is arranged so as to face the convex portions 17 that are aligned in a line at substantially the same arrangement pitch D1 at the positions of the respective sides of the frame shape of the convex portion 18 in the X direction and the Y direction, it is possible to further reduce the difference in the density of the material of the optical path length adjustment layer 32 per unit volume between the region in which the convex portions 17 are arranged and the region in which the convex portion 18 is arranged in the parting region BS.

(5) Since the dummy microlenses MLd that are configured by covering the convex portions 17, which overlap the light shielding portion 31 in a plane, with the optical path length adjustment layer 32 are arranged so as to overlap the light shielding portion 31 in a plane, light that is incident on the microlens array substrate 10 is not transmitted through the dummy microlenses MLd. Therefore, differences in the properties of the dummy microlenses MLd from those of the second microlenses ML2 that are arranged in the display region E do not affect the light that is transmitted through the microlens array substrate 10 due to the diameter D2 of the convex portions 17 that is smaller than the diameter D1 of the convex portions 16.

(6) The liquid crystal device 1 includes the element substrate 20 that is provided with the TFTs 24, the facing substrate 30 that is arranged so as to face the element substrate 20, and the liquid crystal layer 40 that is arranged between the element substrate 20 and the facing substrate 30. Since the facing substrate 30 includes the microlens array substrate 10, the flatness of the surface of the facing substrate 30 is enhanced, and also, the second microlenses ML2 with a uniform property, which are formed of the convex portions 16 of the second lens layer 15, are arranged so as to overlap the opening regions T of the pixels P in a plane. In doing so, it is possible to provide the liquid crystal device 1 that displays a bright image with excellent quality.

(7) Since the projector 100 includes the liquid crystal device 1 that is capable of providing bright display and excellent display quality even if a plurality of pixels P are finely arranged, it is possible to provide the projector 100 with bright display and excellent display quality.

(8) Since the convex portions 17 are arranged in a line in the periphery of the convex portions 16 of the second lens layer 15 according to the method of manufacturing the microlens array substrate, it is possible to reduce the difference in the density of the material of the optical path length adjustment layer 32 per unit volume between the display region E in which the convex portions 16 are arranged and the parting region BS in which the convex portions 17 are arranged as compared with the case in which the convex portions 17 are arranged in a plurality of lines. Since the peripheral edge of the convex portion 18 is removed from the side of the surface of the second lens layer 15 by the predetermined thickness H2, it is possible to reduce the difference in the density of the material of the optical path length adjustment layer 32 per unit volume in the region in which the convex portions 17 are arranged and the region in which the convex portion 18 is arranged. In doing so, it is possible to reduce the number of processes in the flattening processing since the polishing amount is reduced. Therefore, it is possible to enhance productivity of the microlens array substrate 10. In addition, it is possible to enhance flatness of the surface of the microlens array substrate 10 (optical path length adjustment layer 32).

The aforementioned embodiment is only an aspect of the invention, and modifications and applications can optionally be made within the scope of the invention. As a modification example, the following example can be considered.

### MODIFICATION EXAMPLE

The electronic apparatus to which the liquid crystal device 1 according to the embodiment is not limited to the projector 100. The liquid crystal device 1 can be suitably used a display section in an information terminal apparatus such as a projection-type head-up display (HUD), a direct view-type head mount display (HMD), an electronic book, a personal computer, a digital still camera, a liquid crystal television, a view finder-type video camera, a car navigation system, an electronic personal organizer, or a POS.

This application claims priority to Japan Patent Application No. 2015-30391 filed Feb. 19, 2015, the entire disclosures of which are hereby incorporated by reference in their entireties.

What is claimed is:

1. A lens array substrate comprising:
a substrate that includes a plurality of concave portions in a first region on a first surface;
a first lens layer that is formed of a material with an optical refraction index difference from that of the substrate so as to cover the first surface and fill the plurality of concave portions;
a first light transmitting layer that is formed so as to cover the first lens layer;
a light shielding portion that is formed in a second region surrounding the first region on the first light transmitting layer;
a second lens layer that is formed so as to cover the first light transmitting layer and the light shielding portion and includes a plurality of first convex portions arranged in the first region so as to overlap the respective concave portions in a plane and a plurality of second convex portions arranged in the second region so as to overlap the light shielding portion in a plane; and
a second light transmitting layer that is formed of a material with an optical refraction index different from that of the second lens layer so as to cover the second lens layer and includes a substantially flat surface,
wherein the plurality of second convex portions are arranged in a line so as to surround the plurality of first convex portions.

2. The lens array substrate according to claim 1,
wherein the second lens layer includes a third convex portion that is provided in the second region so as to overlap the light shielding portion in a plane and is arranged so as to surround the plurality of second convex portions.

3. The lens array substrate according to claim 2,
wherein the third convex portion is provided in a frame shape.

4. The lens array substrate according to claim 3,
wherein the concave portions, the first convex portions, and the second convex portions are arranged at the substantially same arrangement pitch in a first direction and a second direction that intersects the first direction, and
wherein the width of a portion of the third convex portion in the first direction and the width of a portion of the third convex portion in the second direction are equal to or less than ½ of the arrangement pitch.

5. The lens array substrate according to claim 1,
wherein the diameter of the second convex portions is smaller than the diameter of the first convex portions.

6. An electrooptical device comprising:
a first substrate that includes a plurality of switching elements, each of which is provided for each pixel;
a second substrate that includes the lens array substrate according to claim 1 and is arranged so as to face the first substrate; and
an electrooptical layer that is arranged between the first substrate and the second substrate,
wherein the concave portions and the first convex portions are arranged so as to overlap a region of the pixels in a plane.

7. An electrooptical device comprising:
a first substrate that includes a plurality of switching elements, each of which is provided for each pixel;
a second substrate that includes the lens array substrate according to claim 2 and is arranged so as to face the first substrate; and
an electrooptical layer that is arranged between the first substrate and the second substrate,
wherein the concave portions and the first convex portions are arranged so as to overlap a region of the pixels in a plane.

8. An electrooptical device comprising:
a first substrate that includes a plurality of switching elements, each of which is provided for each pixel;
a second substrate that includes the lens array substrate according to claim 3 and is arranged so as to face the first substrate; and
an electrooptical layer that is arranged between the first substrate and the second substrate,
wherein the concave portions and the first convex portions are arranged so as to overlap a region of the pixels in a plane.

9. An electrooptical device comprising:
a first substrate that includes a plurality of switching elements, each of which is provided for each pixel;
a second substrate that includes the lens array substrate according to claim 4 and is arranged so as to face the first substrate; and
an electrooptical layer that is arranged between the first substrate and the second substrate,
wherein the concave portions and the first convex portions are arranged so as to overlap a region of the pixels in a plane.

10. An electrooptical device comprising:
a first substrate that includes a plurality of switching elements, each of which is provided for each pixel;
a second substrate that includes the lens array substrate according to claim 5 and is arranged so as to face the first substrate; and
an electrooptical layer that is arranged between the first substrate and the second substrate,
wherein the concave portions and the first convex portions are arranged so as to overlap a region of the pixels in a plane.

11. An electronic apparatus comprising:
the electrooptical device according to claim 6.

12. An electronic apparatus comprising:
the electrooptical device according to claim 7.

13. An electronic apparatus comprising:
the electrooptical device according to claim 8.

14. An electronic apparatus comprising:
the electrooptical device according to claim 9.

15. An electronic apparatus comprising:
the electrooptical device according to claim 10.

16. A method of manufacturing a lens array substrate comprising:
forming a plurality of concave portions in a first region on a first surface of a substrate;
forming, on the substrate, a first lens layer of a material with an optical refraction index difference from that of the substrate so as to cover the first surface and fill the plurality of concave portions;
forming a first light transmitting layer so as to cover the first lens layer;
forming a light shielding portion in a second region surrounding the first region on the first light transmitting layer;
forming a second lens layer so as to cover the first light transmitting layer and the light shielding portion;
forming a photosensitive material layer so as to cover the second lens layer;
performing patterning for forming a plurality of first island-shaped sections in the first region so as to overlap the respective concave portions in a plane, a plurality of second island-shaped sections arranged in a line in the second region so as to overlap the light shielding portion in a plane and surround the plurality of first island-shaped sections, and a frame-shaped section that is arranged in a frame shape so as to surround the plurality of second island-shaped sections by exposing the photosensitive material layer to light and cutting the photosensitive material layer;
performing heat treatment for heating the plurality of first island-shaped sections, the plurality of second island-shaped sections, and the frame-shaped section;
performing anisotropic etching on the plurality of first island-shaped sections, the plurality of second island-shaped sections, the frame-shaped section, and the second lens layer to form, on the surface of the second lens layer, a plurality of first convex portions that reflect the shapes of the plurality of first island-shaped sections, a plurality of second convex portions that reflect the shapes of the plurality of second island-shaped sections, and a third convex portion that reflects the shape of the frame-shaped section;
removing a peripheral edge of the third convex portion from the side of the surface of the second lens layer by a predetermined thickness;
forming a second light transmitting layer of a material with an optical refraction index difference from that of the second lens layer so as to cover the second lens layer; and
performing flattening processing of polishing and flattening the surface of the second light transmitting layer.
